(19) United States
(12) Patent Application Publication
(10) Pub. No.: US 2006/0030402 A1
(43) Pub. Date: Feb. 9, 2006

(54) Data-handling, business systems and games

(76) Inventors: Apputhurai Chandrakumar, Kenton (GB); Kulanathan Kularajan, Harrow (JP)

Correspondence Address: WILLIAM COLLARD;COLLARD & ROE, P.C., 1077 NORTHERN BOULEVARD, ROSLYN, NY, 11576, US

(21) Appl. No.: 10/537,145

(22) PCT Filed: Nov. 10, 2003
(86) PCT No.: PCT/GB03/04998

§ 371 Date: Jun. 2, 2005

(30) Foreign Application Priority Data
Dec. 3, 2002 (GB) 0228165.7

(51) Int. Cl. A63F 9/24; G06F 17/00

(52) U.S. Cl. 463/25

(57) ABSTRACT

A fund is set up for a specified maximum of subscribers, who undertake to subscribe a specified amount, each of them by the same specified number of dates, the same amount for each subscriber and each date, the chains of dates possibly only partially overlapping so that the fund can continue to accept new subscribers from time to time. After each subscription date, the amount of the fund is put up for sale by bidding among the subscribers. Each bid comprises the amount that the subscriber is willing to forego in order to obtain the fund amount. The highest bid wins. The amount foregone is split equally between all the subscribers. The promoter takes a specified percentage to cover its commission and expenses. Each subscriber is allowed to win only a limited number of times, e.g. once. The process can be operated by data-handling means (10), as an investment and borrowing business method, or as a game. The means (10); check in respect of a said subscriber that guarantees have been made of subscribing for said number of subscription occasions; limit the number of successful bids that can be made by any subscriber in a fund; run a plurality of funds, that differ, for respective sets of subscribers; display historical and other data for a plurality of available funds to an intending subscriber to choose between them; offer a new subscriber a no-win-no-join choice; operate via Internet or bank cash dispenser network; and access subscriber bank accounts directly. Subscriptions can be paid or guaranteed by an employer. The invention includes programming method and means.

### FIELD OF THE INVENTION

This invention relates to data-handling, business systems and games.

### BACKGROUND

There is a game that is well-known; and has for many years been (and still is) widely played in south-east Asia. This is exemplified by the “chit funds” of Singapore, which are closely regulated by the Singapore Chit Funds Act (last revised in 1985). Of the many compulsory terms and conditions for operating these funds, the majority are prescribed in Section 24 of that Act.

A company, called for this purpose a chit fund company, sets up a fund for a specified number of subscribers, who undertake to subscribe a specified amount (the same for each subscriber on a specified number of dates (the same amount on each date), e.g. monthly. The fund then terminates. The specified number of dates is the same as the specified number of subscribers. After each subscription date, the amount of the fund is put up for sale by bidding among the subscribers by auction or sealed bids. Each bid comprises the amount that the subscriber is willing to forego in order to obtain the fund amount. The highest bid wins. The amount foregone is split equally between all the subscribers. Each subscriber is allowed to win not more than once. The chit fund company takes a specified sum or percentage to cover its commission and working expenses.

Such a chit fund is set up and run rather like a statutory company. Each subscriber has to be provided with a passbook into which the chit fund company must enter each amount received from the subscriber, Auctions are conducted at meetings requiring personal attendance of the subscribers. Sealed bids are tendered by post or in person. If two or more sealed bids tie to win, there must be an auction to decide between them. Before a subscriber can receive the fund amount on a winning bid, he must provide guarantors to ensure that he will continue to subscribe until the termination of the fund, and has two weeks to do so. Regulations also cover defaults.

This game is believed to have started, possibly thousands of years ago, as a barter system for grain, possibly employed when some members of a village did not have enough grain and had to borrow from their neighbours.

### THE INVENTION

The present inventors considered that the existing game is primitive; and, in spite of its long and widespread use throughout south-east Asia, it could be considerably improved in various ways. They realised that the existing game has disadvantages: it is cumbersome, inconvenient, only able to draw on geographically nearby subscribers, of limited scope, lacking in flexibility, of decreasing competitiveness towards the end of the life of the fund, and difficult for regulation, e.g. by the chit fund company or official authorities, whether for taxation, prevention of abuse, or otherwise. They carried out mathematical analyses to determine some of these disadvantages, and to determine better and more interesting ways to play the game. They further realised that, if the game were to be made more flexible and/or more interesting, it would become too complex to be handled by human auctioneers. They realised that it could be desirable to run a game like this by using data-handling means. They therefore analysed the game to devise data-handling means that could be used for playing the existing game and also for playing improved versions of the game, and could be used to apply the game to other purposes, e.g. as a business system. Once the playing of the game is transformed to utilise data-handling means, it is also easy to keep records and make audits, to detect, control and/or prevent manipulation or other abuse, whether by the subscribers or the company, and for official authorities readily to inspect for these purposes and for compliance with tax laws and other regulations.

The game can be applied as a banking system in which there are borrowers and lenders, the “interest” paid by borrowers being paid out to the lenders apart from a small service charge retained by the company running the system. By adoption of suitable rules, the maximum interest paid can be kept lower than the amount or rates usually charged by credit card companies and some banks, say a maximum of 20% per annum, in order to be attractive to borrowers, yet providing substantial rewards for at least some of the lenders so as to be attractive also to lenders. The present inventors perceive that such a system, to be run effectively, requires to be handled by data-handling means.

The system can also be applied for use within a closed circle of subscribers, e.g. within a company or an office, wherein the guaranteed regular payments are made by the employer, either as a deduction from salary or as a reward for efficient working.

One aspect of the invention consists In data-handling means that provide a facility for bidding and a limit condition concerning the number of bids that can be made by an identified subscriber.

Another aspect of the invention consists in data-handling means, adapted to provide an electronic site with secure entry, a facility for bidding, and a limit condition concerning the number bids that can be made by an identified subscriber.

A “site” may be a website but can, for example, be any real or virtual location where information will be available or transactions will occur or where there is the appearance of this. The data-handling means may be distributed but there may appear to users to be a single site.

“Secure entry” means that only those subscribers (which term includes potential subscribers) who are pre-authorised will be admitted (i.e. allowed access) to the site. The site may, for example, be part of a larger site, or associated with another site, which will effect and/or control pre-authorisation, e.g. subject to predetermined conditions and/or investigations, e.g. as to creditworthiness or guarantees. For example, secure entry may be such as to allow only pre-authorised subscribers to access the side or access part of it, where accessing the site may mean allowing access beyond a portal or gateway (that may be external to the site or may be an Initial access part of the site) that checks for pre-authorisation, and secure entry may refer to prevention of access to the site except for pre-authorised visitors.

In the closed circle example, the secure entry feature may be obtained simply by ensuring that the data-handling means are not connected to a public network such as the Internet but are only accessible to those within the closed circle, for example, employees within the company. In such case, the secure entry may not be a feature of the data-handling means, though it may be a feature of the method of use of the data-handling means.

The bidding may be by open auction, in which case all bids that have been made (or at least all bids that have been made on any particular bidding occasion) are accessible to every subscriber, or by sealed tender, in which case each bid is kept secret until the end of bidding, or may be In accordance with some other method.

The bidding limit condition may usually be specified more precisely, though In some cases there may be other forms of a limit condition on the bidding.

Accordingly, another aspect of the invention consists in data-handling means, comprising means to provide an electronic site with

(a) secure entry for subscribers to the site,

(b) a facility for bidding, and

(c) a facility to ensure that an identified subscriber who has made winning bids a predetermined number of times cannot subsequently make a successful bid.

The term “to provide a site with” a feature can mean “to make available a site having” that feature, or “to establish a site having” that feature, or “to equip an existing site with” that feature.

A “winning bid” is a bid upon which the chit fund company is prepared, subject to satisfactory guarantees, to pay out the winnings, e.g. the fund amount (less the amount foregone and the company's specified sum or percentage). Once the chit fund company is ready to pay out on a winning bid, this may be called a “successful bid”. As a feature of the data-handling means, this could for example refer to a feature to authorise or effect payment on a winning bid.

It is assumed that: a subscriber who has won the bidding up to the predetermined number of times has been successful for these bids; or that, if he has failed to have a winning bid converted into a successful bid, e.g. due to failing to provide required guarantees, he is no longer allowed to take part in the bidding.

Usually, facility (c) will be such as to ensure that further bids are not accepted from an identified subscriber who has made a predetermined number of winning bids. A deprecated alternative would be to accept temporarily such further bids, but then to reject any such further bid if eventually it is determined that it would be a winning bid; thus, such a winning bid would not be a successful bid. The word “eventually” has reference to a bid not being determined to have Won until after the close of bidding on a bidding occasion.

Another aspect of the invention consists in data-handling means, comprising means to provide an electronic site with

(a) secure entry for subscribers to the site,

(b) a facility for bidding, and

(c) a facility to ensure that a subsequent successful bid for an identified fungible object is not allowed for an identified subscriber who has made a predetermined number of winning bids for that object.

“Fungible” usually has reference to anything which is available in quantity and of which one unit is precisely equivalent to another unit so that a buyer will not care which particular unit he obtains.

A “fungible object” is hereby defined for the purposes of the present specification as an object which, after being successfully bid for, can be renewed (e.g. replaced with a like object, though possibly in a different quantity or value) and put up for bidding again. An example is an amount of money in a particular fund. In a more particular example, this is the total value of the fund on a bidding occasion (the period during which bidding is permitted, up to the close of bidding), in which case, after the amount (subject to any deductions, as explained below) has been awarded to the successful bidder, it can be renewed (to the same or a different value) for a subsequent bidding occasion. It could equally be stocks, shares, grain or any other commodity. For different funds within a scheme, there would correspondingly be different fungible objects, though usually not of different kinds.

It is possible for the fungible object to be a complex object, provided that its nature has been agreed between the subscribers and the company running the site. For example, each subscriber may contribute a work of art on each subscribing occasion, all of the works of art (from all subscribers, on all occasions) having substantially the same predetermined value, the total pool of such objects on each occasion forming the fungible object.

The system can also be adapted for the fungible object (and subscriptions) to increase in value on subsequent (possibly successive) bidding occasions. Because of the number of variables that would then be Involved, the system could not be handled by human beings and would have to be run by suitable data-handling means.

Preferably, said predetermined number is two or one. This can ensure that one subscriber is not able to manipulate the bidding or perpetrate other abuse. To enable one and the same identified subscriber to make two winning bids for that fungible object, he would need to take out the same number (two) of subscriptions. Likewise for any other number.

Usually, said data-handling means will comprise means to provide said site with a plurality of subdivisions, each adapted to allow bidding for a separate said fungible object. This will, for example, allow a plurality of the aforesaid funds, one to a subdivision. For clarity, it will be assumed that a subdivision will terminate together with its fungible object. However, it may be desirable for a site subdivision to be utilised repeatedly, i.e. for successive fungible objects. Possible reasons for this are: to minimise the need to set up new subdivisions, e.g. if this is complicated, expensive or a difficult; simply to allow suitably pre-authorised subscribers for that subdivision to subscribe to a new fungible object without the need for further pre-authorisation; if a subdivision is given a name, subscribers might prefer, or be tempted, to continue subscribing to the same name. Of course, such use of a name can alternatively be achieved by data-handling means adapted to transfer a name from a terminated subdivision to a new subdivision.

Preferably, said data-handling means will comprise means to provide a said subdivision with secure entry, that is, to allow only those subscribers pre-authorised for that subdivision to access it. This will, for example, allow a subscriber access to only a limited number of subdivisions, e.g. corresponding in total to his creditworthiness.

To facilitate transformation of the game to use of data-handling means, and to speed up the game, said data-handling means comprise guarantee-checking means adapted to check, before a subscriber is allowed to bid, that he has creditworthiness or other guarantees for his continuing to subscribe on all subsequent bidding occasions after he has won, and consequently give him pre-authorisation to bid. This pre-bid guarantee check is an important difference from the Singapore game. In the closed circle example, the equivalent of this check may simply be the closed circle. Preferably, the guarantee-checking means are adapted to effect such a check (perhaps in addition to a bid-by-bid check) in order to issue the pre-authorisation before the subscriber is first allowed access to a subdivision. More preferably, the guarantee-checking means are adapted to effect such a check in order to issue the pre-authorisation before the subscriber is allowed access to the site for the purpose of bidding. The term guarantee here means that, if the subscriber fails to continue subscribing, the guarantors will subscribe in his place. This guarantee-checking facility of course is not needed in the example given above wherein the employer guarantees subsequent payments.

For use in playing relevant games, said data-handling means comprise means to check that a winning subscriber is adequately guaranteed (either by checking on that occasion, or by previously having checked, e.g. to issue pre-authorisation), and then to calculate any tax or other prearranged deduction (e.g. the amount paid to the party running the game), his winnings to be paid out to him, and the part of his winning bid to be paid out to each subscriber.

For use in playing the known (Singapore) game, said data-handling means comprise means to ensure that a subdivision is not first opened for bidding until it has a specified number of subscribers, and i is then open for bidding only for those subscribers and only for the same specified number of bidding occasions. Usually, the bidding will follow the subscriptions, so that the latter means are adapted to ensure that the subdivision is not opened for receiving subscriptions until it has the specified number of subscribers, i.e. such subscribers have indicated, agreed or undertaken that they will subscribe to such a subdivision, and been assigned to this one. After the specified number of bidding occasions, the data-handling means will ensure that the subdivision terminates, or at least that that fungible object terminates by no longer being renewable.

For use In playing a variation devised by the inventors, said data-handling means comprise means adapted to ensure that a subdivision is not first opened for bidding until it has a predetermined minimum number of subscribers (possibly one, but preferably two), and it is then open for bidding only for a specified maximum number of subscribers, and only for the same specified number of successive bidding occasions for each subscriber regardless of when he starts to subscribe to the subdivision. This allows much more flexibility in the game, allows competitiveness to Increase as well as decrease, and allows a fungible object within a subdivision to continue to be renewed Indefinitely, or at least beyond said specified number of bidding occasions. Said data-handling means may be adapted to ensure that once a subscriber has completed subscribing for the specified number of successive bidding occasions, his subscription expires; but, preferably, said data-handling means are adapted to allow him to open another subscription for the same fungible object. As mentioned above, said data-handling means may be adapted to allow him to have a maximum of, preferably, two subscriptions running at the same time for the same fungible object, not necessarily started at same time.

Data-handling means embodying the invention may comprise any one or more of the following:
means to provide for said predetermined number to be two.
means to provide for said predetermined number to be one.
means to provide an electronic she with a facility to check that a subscriber to the site has provided guarantees of making subscriptions in respect of a predetermined number of subscription occasions.
means to provide an electronic site with a facility to check that a subscriber to the site has provided guarantees of making subscriptions in respect of a predetermined number of subscription occasions before allowing the subscriber to bid.
means to provide said site with a plurality of subdivisions, each adapted to allow bidding for a separate identified fungible object.
means adapted for a said fungible object to be a monetary fund.
means to terminate a subdivision together with is fungible object.
means to provide a said subdivision with secure entry, that is, to allow only those subscribers pre-authorised for that subdivision to access it.
comprising means to provide a facility to allow a subscriber access to only a predetermined limited number of subdivisions.
comprising guarantee-checking means adapted to check, before a subscriber is allowed to bid, that he has creditworthiness or other guarantees for his continuing to subscribe on all subsequent bidding occasions of a predetermined number after he has won, and consequently give him pre-authorisation to bid.
the guarantee-checking means are adapted to effect such a check so as to issue the pre-authorisation before the subscriber is first allowed access to a subdivision.
the guarantee-checking means are adapted to effect such a check so as to issue the pre-authorisation before the subscriber is allowed access to the site for the purpose of bidding.
means to check that a winning subscriber is adequately guaranteed, and then to calculate any tax or other pre-arranged deduction, his winnings to be paid out to him, and the part or parts of his winning bid to be paid out to each subscriber.
means to effect such payments.
means to ensure that a subdivision is not first opened for bidding until it has a specified number of subscribers, and it is then open for bidding only for those subscribers and only for the same specified number of bidding occasions.
means adapted to ensure that the subdivision is not opened for receiving subscriptions until it has the specified number of subscribers.
means to ensure that the subdivision terminates after a number of subscription and bidding occasions equal to the specified number of subscribers.
means to specify the maximum number of bidding occasions for each subscriber to the subdivision and to ensure that the subdivision is allowed to continue for more than this number of bidding occasions.
means to ensure that a subdivision is not first opened for bidding until it has a predetermined minimum number of subscribers, and it is then open for bidding only for a specified maximum number of subscribers, and only for the same number of successive bidding occasions for each subscriber regardless of when he starts to subscribe to the subdivision.
means to ensure that once a subscriber has completed subscribing for the specified number of successive bidding occasions, his subscription expires.
means to allow a subscriber, after his subscription expires, to open another subscription for the same fungible object.
means to allow a subscriber to have a maximum of two subscriptions running at the same time for the same fungible object, not necessarily started at same time.
means adapted to enable a subscriber upon starting a subscription to choose whether to bid on his first bidding occasion.
means adapted to enable a subscriber upon starting a subscription to withdraw his subscription if he fails to win on his first bidding occasion.
the data-handling means are connected or adapted to be connected to a funds transfer machine, which term includes an automatic transfer machine (commonly known as ATM or a bank cash dispenser machine), for such machine to be used by a subscriber as a terminal for utilising the electronic site.
the data-handling means are connected or adapted to be connected to, or adapted to interrogate, a financial account of a subscriber held on data-handling means, to obtain from the latter in relation to such account a guarantee of making subscriptions in respect of a predetermined number of subscription occasions.
the data-handling means are adapted to render a direct debit to said financial account In respect of a subscription occasion for the electronic site.
the data-handling means are adapted, in conjunction with the data-handling means of the financial account, to obtain a guaranteed payment in respect of a subscription occasion.
display means adapted to provide a display of those subdivisions for which a subscriber can be pre-authorised.
display means adapted to provide for an identified subscriber a display of those subdivisions for which he is pre-authorised.
display means adapted to provide for an identified subscriber pre-authorised for a subdivision a display of current bids for that subdivision.
display means adapted to provide for an identified subscriber pre-authorised for a subdivision a display of current and previous bids for that subdivision.
means to establish and/or register a credit limit for a said subdivision, e.g. monthly or per bidding occasion.
means to establish and/or register a credit limit for a subscriber.
means to effect and/or control pre-authorisation for a subscriber for a said subdivision in dependence upon a credit limit for the subscriber and credit limits for that subdivision and for all other subdivisions for which the subscriber is pre-authorised.
means to store previous bids for a subdivision and make these, or some of them, or selected ones of them, or selected kinds of them, available for access by a subscriber.
means to pre-authorise a subscriber for a subdivision.
means to offer a subscriber a choice whether to subscribe or not upon a particular access.
monitor means adapted to provide information by printing, displaying, storage or otherwise in a restricted access manner due to location, coded access or otherwise, so that suitably authorised communicatees, e.g. organisers of the facility, can access the information but communicatees, e.g. subscribers, unauthorised for this purpose can not.

Another aspect of the invention provides data-handling means adapted to run a bidding facility, characterised in that the data-handling means are adapted to run a subscription and bidding facility for at least one set of subscribers to the facility, and comprise means to limit the number of successful bids that can be made by an identified subscriber in the set.

Data-handling means embodying the invention may comprise any one or more of the following:
means to limit the number of successful bids that can be made by an identified subscriber in the set to two,
means to limit the number of successful bids that can be made by an identified subscriber in the set to one.
means to specify a number for the set and to check in respect of a said subscriber that guarantees have been made of subscribing for that number of subscription occasions.
means to carry out the check before allowing the subscriber to make a bid.
means to carry out the check before allowing the subscriber to start subscribing.
means to ensure for a said subscriber that said number is the maximum number of subscription occasions and bidding occasions and check that subscription is made in respect of all of such number of subscription occasions.
means to ensure that said number is the only number (apart from default) of subscribers allowed In the set at any onetime and the subscribing and bidding facility for the set cannot start to run until that number of Intending subscribers has been reached.
means to ensure that said facility for said set terminates upon completion of said number of subscribing and bidding occasions.
means to ensure that said number is the maximum number of subscribers allowed in the set at any one time.
means to specify a starting number for a set and ensure that the set has this number of intending subscribers before the subscription and bidding facility can run for the set
means to allow the subscription and bidding facility to continue to run for more than said maximum number of subscription and bidding occasions.

Another aspect of the invention provides data-handling means adapted to run a bidding facility, characterised in that the data-handling means are adapted to run a subscription and bidding facility for at least one set of subscribers to the facility, and comprise:

means to facilitate a string of successive bidding occasions and ensure that on each of them only one successful bid is allowed;

means to ensure that a subscription occasion precedes each bidding occasion;

means to specify a number characteristic for the set, to specify this as the number of successive bidding occasions constituting a chain of such occasions within said string, to associate an identified subscriber with a said chain, to check that in respect of such subscriber guarantees have been made of subscribing for that chain, and to ensure that the subscriber's subscription expires at the end of said chain;

and means to limit the number of successful bids that can be made within that chain by that identified subscriber.

Data-handling means embodying the invention may comprise any one or more of the following:
means to ensure that an identified subscriber can participate in the facility for only one said chain in a said string.
means to ensure that an identified subscriber can participate in the facility for not more than two of said chains in a said string at a time.
means to ensure that an identified subscriber can participate In the facility for only one said chain at a time in a said string.
means to ensure that a said string has only the length of one said chain.
means to allow a said string to be longer than one said chain.
the data-handling means are adapted to provide an electronic site with: secure entry, a facility for bidding, and a limit condition concerning the number bids that can be made by an identified subscriber.

General advantages of various systems embodying the invention are:

1) They enable a chain to start with one or more members, i.e. with less than the maximum designated for that chain

2) They will draw people from far away as well as people close by (whereas the old system was only able to draw people from nearby)

3) The subscribers can make informed decisions from Information on the displays and have enough time to review the other bids before bidding themselves

4) They will let people leave the chain, i.e. allow flexibility

5) They can be more efficient and can be easily monitored to comply with changes In law and other circumstances and can be adapted to suit local laws

6) They are more efficient in providing the public with a possibility to borrow at less cost and save at a higher return than with other banking systems currently available

7) They cannot be manipulated by subscribers as the data-handling means is programmed to control the events

8) They will not be as prejudicial as prior systems against bids being competitive towards the end of a bidding chain, because the subscribers have the flexibility to leave the string and join at any time, so renewed or sustained pressure is there to keep the bidding at a moderate level throughout the life cycle of a chain

9) The chain can be programmed to secure a win by making a predetermined maximum bid during any bidding occasion

10) The string will not have a predetermined life span

11) They are designed to hold the history and statistics of subscribers and strings, so the subscriber can access past information (May be linked to point 3)

12) They will limit a subscriber to having a maximum number of simultaneous subscriptions in a chain, say two, so the chain cannot be manipulated by the subscribers

13) They can avoid or reduce the need to use human judgment

14) They can enable every bid to be timed precisely, and thus can handle in unambiguous timed order a large number of almost simultaneous bids.

Another aspect of the invention provides means for programming data-handling means, which programming means are adapted to programme the data-handling means to be data-handling means as mentioned above.

Another aspect of the invention provides software adapted to provide data-handling means embodying the invention with any of the features mentioned above.

Another aspect of the invention provides any part of data-handling means embodying the invention, which part is within the jurisdiction of the courts.

Another aspect of the invention provides a method of setting up or operating data-handling means to process information, or a method of processing Information, in which method there is provided a facility for bidding and a limit condition concerning the number of bids that can be made by an identified subscriber.

Another aspect of the invention provides a method of setting up or operating data-handling means to process information, or a method of processing information, in which method there is provided a facility for bidding, a limit condition concerning the number of bids that can be made by an Identified subscriber, and a check of guarantees as to funds transfer from the subscriber before the subscriber is allowed to make a bid.

Another aspect of the invention provides a business system, which comprises data-handling means as mentioned above, adapted to receive investment funds from a said subscriber and to pay out loan funds to a said subscriber.

Another aspect of the invention provides a game, which comprises data-handling means as mentioned above, and rules (which may be built into the data-handling means) for players to play the game as said subscribers.

Another aspect of the Invention provides a game which comprises use of data-handling means as mentioned above, according to rules (which may be built into the data-handling means) for players to play the game as said subscribers.

Such rules may include that one bidder may not have more than a predetermined number of successful bids. This may be at all or during a predetermined interval, or during an interval that is not predetermined but depends upon data or parameters that appear or change, e.g. as time, or the bidding, progresses. Such predetermined interval may be measured in time, transactions, bidding occasions or otherwise; “at all” may for example be the duration of the scheme (e.g. the string, or the total operation of the system).

Another aspect of the invention provides a method of conducting electronic commerce involving the exchange of investments and borrowings amongst a plurality of network registrants, the method comprising: accepting from a plurality of said network registrants offers of investment; auctioning groups of one or more of the investment offers among the network registrants; receiving from at least one of said network registrants a bid for a borrowing of a said group; ensuring that not more than a predetermined number of bids is successful from said one registrant.

Another aspect of the invention provides a machine-implementable method of auctioning in which bids are received but a bidder is not allowed to have more than a predetermined number of successful bids. This may be used in a business method or in a game.

The number of permitted successful bids may vary from one registrant to another, e.g. depending upon creditworthiness.

Generally, a preferred feature is that a subscription period precedes each bidding period.

Generally, a preferred feature is that a funds transfer guarantee check precedes permission to make a bid.

A further aspect of the invention provides a method for digitally processing bids, which method ensures that a bidder does not have more than a predetermined number of successful bids.

Yet a further aspect of the invention provides a system for digitally processing bids, which system ensures that a bidder does not have more than a predetermined number of successful bids.

Means embodying the invention may comprise means adapted for any one or more of the following facilities, and a method embodying the invention may comprise any one or more of the following facilities:
to enable a subscriber upon starting a subscription (or joining a subdivision) to choose whether to bid on his first bidding occasion.
to enable a subscriber upon starting a subscription (or joining a subdivision) to withdraw his subscription (preferably without penalty) if he falls to win on his first bidding occasion.
to provide a display of those subdivisions for which a subscriber can be pre-authorised.
to provide for an identified subscriber a display of those subdivisions for which he is pre-authorised.
to provide for an identified subscriber pre-authorised for a subdivision a display of current bids for that subdivision. The term “current bids” has reference to bids made during the currently open bidding period.
to provide for an identified subscriber pre-authorised for a subdivision a display of current and previous bids for that subdivision.
to establish and/or register a credit limit for a said subdivision.
to establish and/or register a credit limit for a subscriber.
to effect and/or control pre-authorisation for a subscriber for a said subdivision in dependence upon a credit limit for the subscriber and credit limits for that subdivision, and for all other subdivisions for which the subscriber is pre-authorised.
to store previous bids (or some of them, or selected ones of them, or selected kinds of them) for a subdivision and make these, or some of them, or selected ones of them, or selected kinds of them, available for access by a subscriber, e.g. by displaying them to the subscriber, e.g. upon request.
to pre-authorise a subscriber for a subdivision.
to offer a subscriber a choice whether to subscribe or not upon a particular access.

### DESCRIPTION RELATING TO THE DRAWINGS

Reference will now be made wide way of example to the accompanying drawings, which are schematic block diagrams of data-handling means embodying the invention and flow charts of methods embodying the invention, in which like references denote items having like functions. In the drawings:

FIGS. 1 to 6 are simplified schematic block diagrams of means embodying the invention;

FIG. 7 is a more detailed schematic diagram of means embodying the invention;

FIG. 8 is a simplified schematic block diagram of a network embodying the invention;

FIG. 9 is a flowchart illustrating some possible procedures embodying the invention;

FIG. 10 is a flowchart illustrating some possible procedures embodying the invention when using the system illustrated in FIG. 7;

FIGS. 11 to 17 are flowcharts illustrating procedures embodying the invention akin to the FIG. 10 embodiments and parts of such procedures; and

FIG. 18 is a detail of FIG. 7.

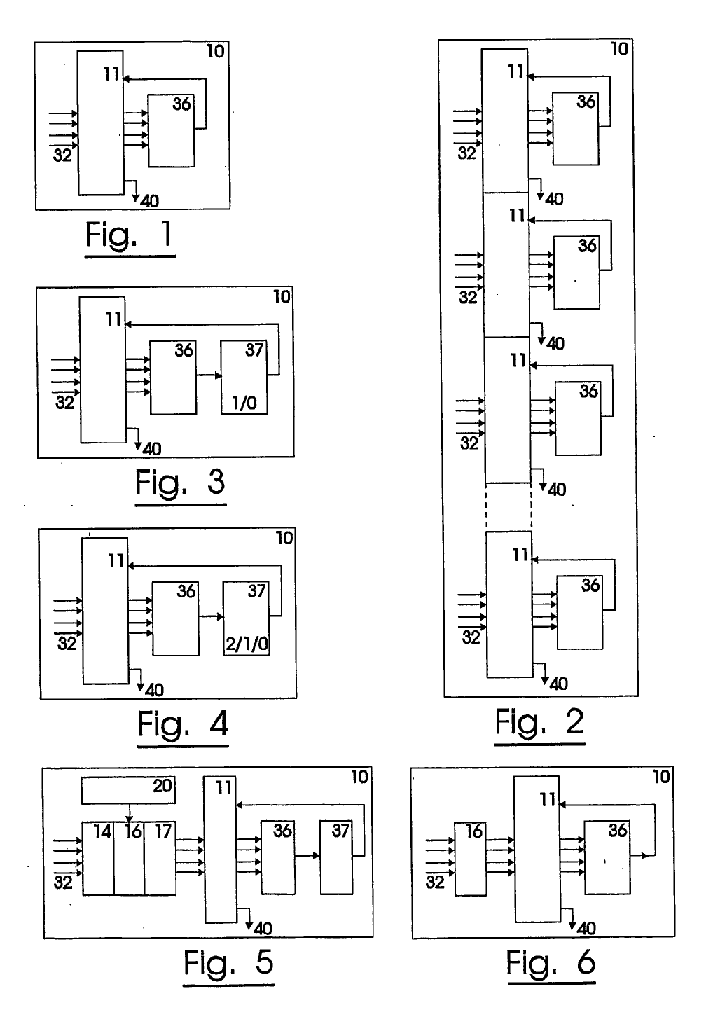

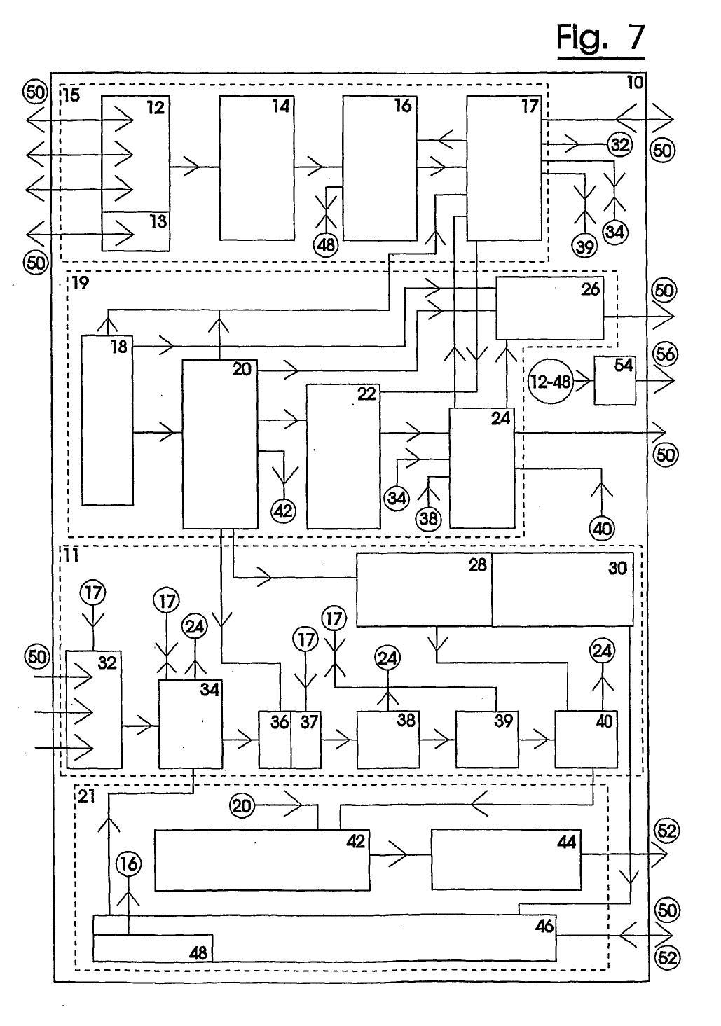

Referring to the drawings, the references in the following list are used in relation to FIG. 7, and some of them correspondingly in relation to FIGS. 1 to 6 with some minor variations of details as will be explained:

10=Data-handling means

11=Means to provide a bidding facility

12=Interactive input means to receive applications made to be new bidding subscribers

13=Means to offer the possibility that an application can be made to be a temporary (conditional) subscriber

14=Means to identify subscribers and assign them a customer number, password, profile and so on

15=Means to Identify new subscribers, and old subscribers making a new application to join a string, profile them, register their details, and control their access to strings

16=Means to check subscriber pre-authorisation and assign them a credit limit

17=Register of permitted subscribers (pre-authorised subscribers whose subscriptions are up-to-date; or whether they are temporary and for which bidding occasion); also noting: their credit limit; when their subscription expires (how many more bidding occasions); and the number of winning bids they have made; and displaying this to them (e.g. upon request)

18=Means to identify an object to be auctioned and a string for that object

19=Means to define strings and control their operation

20=Means to set conditions for the string

21=Means to obtain guarantees and subscriptions, and to make payments

22=Means to initalise the string (if appropriate)

24=Means to register the current state of the string and display this information upon request Including count of the bidding occasions

26=Means to display this information for this and other strings

28=Means to time and close each bidding period

30=Means to time each subscription period

32=Input means to receive bids and identify them with their subscribers

34=Means to check bids and accept only those from pre-authorised subscribers whose subscriptions are up-to-date or pre-authorised temporary bidders for this bidding occasion

36=Means to limit the number of successful bids of a subscriber

37=Means to set number level of permitted further successful bids for individual subscribers

38=Accumulator means to compare permitted bids and note the winner so far

39=Means to note if winner is temporary and to designate the winner as now normal (non-temporary) and to delete other temporary bidders registered for that bidding occasion

40=Means to note the winning bid, to notify temporary subscribers of new status as deleted or normal, and to update the current string state record after a winning bid has been determined

42=Means to calculate the payments for the winning and other subscribers

44=Means to make these payments to the subscribers

46=Means to make direct debits for subscriptions and to check subscriptions have been duly made by direct debit or other method

48=Means to obtain guarantees

50=Funds transfer machines or other terminals, e.g. automatic transfer machines (commonly known as ATMs or a bank cash dispenser machines)

52=Data-handling means holding financial accounts of subscribers

54=Monitor means to gather information, and provide information in a restricted access manner

56=Privately located or accessible means to receive and display information from means 54 to suitably authorised higher level communicatees, e.g. organisers of the facility

In FIG. 7, a reference number in a circle indicates that the adjacent connection goes to an item with that reference number. The arrowheads indicate the direction of information flow.

Referring to FIG. 1, data-handling means 10 comprise means 11 to provide a facility for bidding and means 36 to provide a limit condition concerning the number of bids that can be made by an identified subscriber.. In this simple embodiment, input bids are received from external input means 32 and the winning bid is notified to external means 40.

The means 10 may be dedicated and structured to provide said facility and limit condition. Alternatively, for example, means 10 may be more general data-handling means configured by software so as to be adapted to run said facility with said limit condition.

Referring to FIG. 2, data-handling means 10 are adapted to run a bidding facility, and more particularly comprise means 11 adapted to run a subscription and bidding facility for at least one set of subscribers to the facility, and comprise means 36 to limit the number of successful bids that can be made by an identified subscriber in the set. Means 10 may comprise a plurality of means 11 and 36, one for each set of subscribers, the various means 11 being Interconnected so that, for example, they can have a common bank of information concerning a subscriber belonging to more than one of set sets.

As illustrated by way of example in FIG. 3, the data-handling means 10 may comprise means 37 (as a stand-alone unit 37 or as a part of means 11) to limit the number of successful bids that can be made by an identified subscriber in the set to two. For this purpose, such means 37 may set three levels, 2, 1, 0, to be associated with each subscriber to a particular set to indicate to means 11 how many successful bids may be made by that subscriber. The level for a particular subscriber will change down one after he has made a successful bid. As illustrated by way of example in FIG. 4, means 37 may limit the number of successful bids that can be made by an identified subscriber in the set to one, e.g. by setting only two levels, 1, 0.

As illustrated by way of example in FIG. 5, means 10 may comprise means 20 to specify a number for the set and means 14 to identify and profile a subscriber, and means 16 to check in respect of a said subscriber that guarantees have been made of subscribing for that number of subscription occasions. Means 16 are preferably arranged to carry out the check before allowing the subscriber to make a bid, either before each bid or preferably before allowing the subscriber to start subscribing (or at least before allowing the subscriber to start subscribing for a chain of said number of bids). Means 16 and 17 may ensure that, for a said subscriber, said number is the maximum number of subscription occasions and bidding occasions and check that subscription has been made in respect of all of such number of subscription occasions.

In connection with the Internet, bank cash dispenser networks and possibly other arrangements, there is, or can effectively be, provided an electronic site at which visitors can view information interactively. Such a site may be dedicated exclusively to providing an embodiment of the invention or may be available for other purposes and include an embodiment of the invention. Data-handling means embodying the invention may therefore be adapted to provide an electronic ste with: secure entry, a facility for bidding, and a limit condition concerning the number bids that can be made by an identified subscriber, e.g. comprising means 16 for secure entry, means 11 for a bidding facility, and means 36 to limit the number of successful bids; as illustrated by way of example in FIG. 6.

Thus, means 16 can provide secure entry for subscribers to the site, that is, to allow only authorised subscribers to access the site or access a relevant part of it, means 11 can provide a facility for bidding, and means 36 can provide a facility to ensure that an identified subscriber who has made winning bids a predetermined number of times cannot subsequently make a successful bid. Access to the site may mean access beyond a portal or gateway (that may be external to the site or may be an initial accessible part of the site) that authorises or checks for authorisation (satisfying predetermined criteria) or pre-authorisation (recognising that the visitor has previously been authorised).

In one embodiment, means 17 ensure that said number is the only number (apart from default) of subscribers allowed in the set at any one time and the subscribing and bidding facility for the set cannot start to run until that number of intending subscribers has been reached. In one form of this embodiment, means 17 and 20 ensure that said facility for said set terminates upon completion of said number of subscribing and bidding occasions; this manner of conducting bidding has a feature of the Singapore arrangement, in that it allows only one chain of bidding, and this is simultaneous for all subscribers.

In another embodiment, means 17 and 20 ensure that said number is the maximum number of subscribers allowed in the set at any one time, and may also specify a starting number for a set and ensure that the set has this number of intending subscribers before the subscription and bidding facility can run for the set. In a variation of this embodiment, means 17 and 20 may allow the subscription and bidding facility to continue to run for more than said maximum number of subscription and bidding occasions.

A more detailed embodiment is shown in FIG. 7. The items illustrated have the functions indicated in the above list.

Referring now to FIG. 7, data-handling means 10 comprise: means 11 to provide a bidding facility; means 15 to identify new subscribers (and old subscribers making a new application to join a string, i.e. to start a first or another chain within a string), profile them, register their details, and control their access to strings (this last function serving as one control on operation of bidding facility means 11); means 19 to define strings and control their operation (this last function serving as another control on operation of bidding facility means 11); and means 21 to obtain guarantees and subscriptions, and to make payments. Means 15 serve mainly to process information from subscribers. Means 19 serve mainly for initial and/or external setting of operating conditions. Both of means 15 and 19 control operation of bidding facility means 11. Means 21 with means 15,19 and 11 and external means 50, 52 for finance purposes.

From another aspect, data-handling means 10 comprise: (3 input and operating means, namely, means 11 to provide a bidding facility, with means 18 and 20 to determine the conditions of operation of the facility, means 12 and 13 to receive applications to be new bidders, means, 32 to receive bids; (ii) display means, namely, means 17 to display subscriber information, means 24 to display the current state of one string of bidding occasions for which a subscriber is authorised, means 26 to display similar information for this and other strings; (iii) subscription means to obtain and check subscriptions and guarantees and make payments, namely, means 16 to check authorisation of subscribers, means 46 and 48 to obtain subscriptions and/or guarantees, means 44 to make payments; and (iv) monitor means, namely, means 54 to monitor operation of the data-handling means 10.

Connections for information transfer (at least In the directions shown by the arrowheads) are as shown in FIG. 7, though there may be different and/or further such connections between the various means as required by different embodiments and/or methods of operation.

Means 12 are interactive input means connected or adapted to be connected to receive applications to be new bidding subscribers, input by way of terminals 50. Means 12 provide information and questions to an Intending subscriber, and 35 receive interactively from him information and answers. Means 13, within means 12, offer a facility for an application to for a conditional new subscriber, who would only become a subscriber if his initial bid (made at the time of the application) is a winning bid. Means 12 and 13 also handle an application from an old subscriber to join a new string. Means 14 are connected to receive the information from means 12 and 13 and use this to identify the subscriber and assign him individual identification information and a profile, unless he is art old subscriber, identified by using a membership or other identity number and a password. Means 16 hold information about the subscriber in a temporary holding area of means 16 and check that the identified subscriber has appropriate (see below) pre-authorisation, by interrogation of means 17 which holds this information for old subscribers (see below). If this fails, Including the case that the authorisation is no longer appropriate, means 16 sends the subscriber information to means 48 which obtains guarantees of future subscriptions, or at least records when there are guarantees in place, e.g. as input to means 48 by the administrators of the system in respect of identified potential or old subscribers. The pre-authorisation is effectively that a required number of subscriptions have been pre-paid or that guarantees of future subscriptions have been provided to data-handling means 10, and that these are appropriate to the subscriber's choice of one or more strings at means 12 and 13, or that an appropriate credit limit has been allowed to the subscriber. If the check at means 16 fails, possibly after interrogation of means 17 and interrogation or use of mean 48, means 16 rejects the application.

Means 17 is a central register of permitted subscribers and is connected to obtain information about them, initially (as new subscribers) from means 14 and 16, and afterwards (during their permitted string of bidding occasions) from means 18 (identifying one or more strings relevant to a subscriber), means 20 (identifying conditions relevant to a subscriber for each such string relevant to that subscriber), means 34 (to indicate bids made by that subscriber), and means 39 (concerning a subscriber if they have won). Means 17 is also connected to obtain information from means 24 concerning the current state of each string and integrate this with the information concerning the subscribers relevant to that string. Means 17 is also connected to supply information concerning subscribers to means 32 to identify them when they make bids subsequent to their initial application, and to means 34 to control whether a bid will be permitted. Subscriber register means 17 is also connected to terminal means 50 to supply information concerning a subscriber, to himself, interactively upon request.

Means 18 are set up (initially, or from time to time, e.g. according to some scheme, e.g. which may be pre-programmed into means 18) to identify each string, e.g. string number 151, and an object to be auctioned using that string, e.g. the nominal fund value of that string, e.g. £1200 if there are 12 subscribers and the subscription on each subscription occasion (preceding a bidding occasion) is £100, and possibly a start date for the string. Means 18 are connected to supply this information to register means 17 and to strings display means 26. Means 20 are connected to receive information from means 18 identifying each string and to set conditions (by pre-programming, and/or by being conditionally responsive to incoming information, and/or by being set from time to time) for the string, (e.g. the number of successful bids that may be made by a subscriber to a string, the number of subscription and bidding occasions permitted to a subscriber to the string, the size of a subscription to the string, the maximum number of subscribers to the string, the maximum and minimum possible bids, usually as percentage discounts on the fund value, and the timing of subscription and bidding periods) and to feed this information to central register means 17 to be integrated with the subscriber information, to strings display means 26, to timing means 28 to time and close each bidding period and timing means 30 to time and close each subscription period, and to limit means 36 to limit the number of successful bids of a subscriber for the string.

Means 22 are connected to receive the string condition information from means 20 and further information from means 17 (e.g. how many subscribers are currently in the string) and initialise (set initial conditions for) the string, e.g. for each new subscription period within the string, e.g. the number of places still available for new subscribers to the string. Means 24 are connected to receive this information and pass it (with other information) to central register means 17 both to integrate this with the subscriber information and to operate the string, to display means 26 and, upon request, to terminal means 50.

Means 17, besides being subscriber information register means also, in accordance with incoming information, control the admission of subscribers to a string and control the operation of the string. For this purpose, means 17 are connected to receive relevant information from means 20 and 24 to operate the string, to use this information to control which subscribers can subscribe to the string and under what conditions, and to supply corresponding control information for these purposes to means 32 (to supply identification information to identify subscribers making bids), 34 (to permit bids only from pre-authorised subscribers and only in accordance with the operating conditions for a string), 37 (to set the current level of the permitted number of winning bids for a particular subscriber to a string, taking into account how many they are allowed and how many they have already made) and 39 (to deal with temporary subscribers upon a winning bid).

Bidding facility providing means 11 comprise: (I) input means 32 connected or adapted to be connected to receive bids from terminal means 50 and information from means 17 to identify bids with their subscribers; (II) means 34, 36 and 37 connected as and for the purposes described above for these means, generally to control the operation of the bidding facility in accordance with input information; (III) means 28 and 30 connected as and for the purposes indicated above for these means, generally to time the successive subscription and bidding occasions; and (I) means 38, 39 and 40 connected as and for the purposes described above for these means, generally to compare the bids, select the winning bid and indicate this.

Means 42 are connected to receive, on each bidding occasion, string financial condition information from means 20 and winning subscriber identification and bid from means 40, and calculate payments to the winning subscriber and other subscribers. Means 44 are connected to receive this information from means 42 and connected to data-handling means 52 holding subscriber accounts, e.g. bank accounts, to effect the calculated payments to the subscribers relevant to that string on that bidding occasion.

Means 46 are connected to means 30 to receive timing for each subscription period, are connected to subscriber account means 52 to take subscriptions by direct debit and to terminals 50 for subscribers who wish to effect funds transfer themselves on each subscription occasion, and are connected to means 34 to indicate that subscriptions have been received. Means 48 form part of means 46 and are connected or adapted to be connected to subscriber account means 52 for some subscribers in order to provide one method of obtaining guarantees of subscriptions, and possibly obtaining information upon which to base permitted credit limits for a subscriber. Means 16 are connected to receive this information from means 48 in order to check subscriber pre-authorisations and assign credit limits,

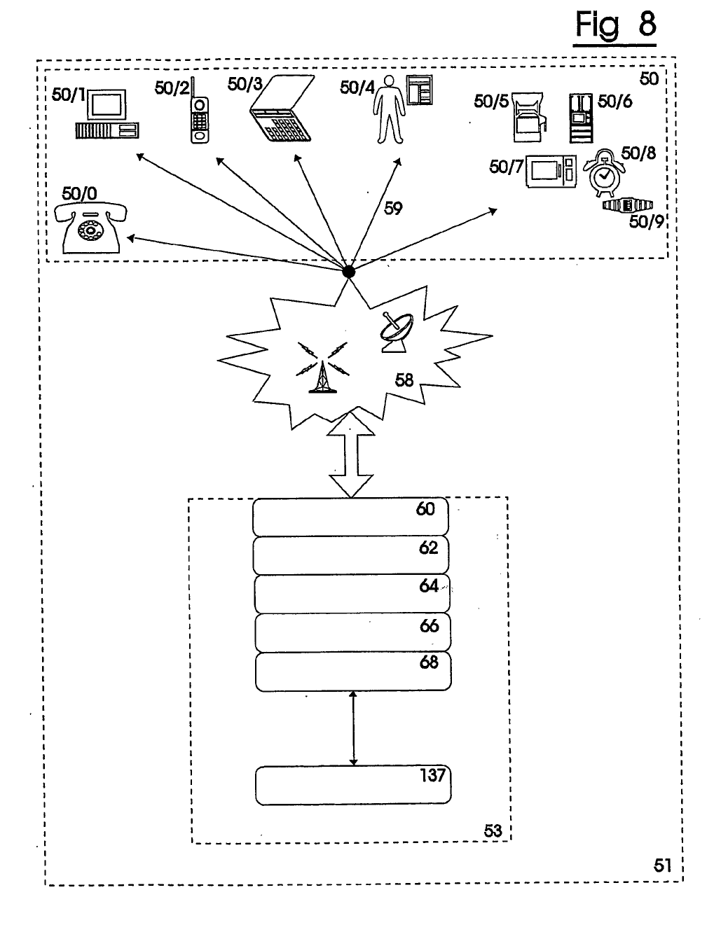

The system is provided with a facility to enable every bid to be timed precisely, so that i can handle in unambiguous timed order a large number of substantially simultaneous bids. These may be timed as the instant of clicking of the Submit button seen in Table 1 (or at least when the bid then submitted reaches the central processing unit 10). Referring to FIG. 18, the system has a plurality of (simultaneous) input channels 59, FIG. 8, from terminals 50 to bid input means 32, FIG. 7. Means 32 comprise a clock 200 (which also provides clock pulses for timing means 28, 30) timing say microsecond intervals for subscriber identification means 202 in each of which intervals the bidding facility can accept only one bid it is assumed that, while the bids arrive less frequently than one per microsecond on average, they may actually arrive in bunches within a single 1/10 microsecond. The incoming bids in the form of coded signals on channels 59 reach timing means 204 which, under the control of clock 200, adds to each signal data identifying its channel 59 and the time the bid is received, say to 1/10th microsecond. These signals are then stored in buffer 206 in timed order, and possibly in a predetermined or hierarchical channel order within each basic time interval of say 1/10th microsecond. Under the control of clock 200 the are then downloaded from the buffer at a rate of not more than one per microsecond. Alternatively, the buffer may comprise for the downloading a multiplex decoder which sweeps stores for the respective channels in said channel order.

Some particular features of the FIG. 7 arrangement are now mentioned together with some variant embodiments. The data-handling means 10 are adapted to run a bidding facility, i.e. a subscription and bidding facility for at least one set of subscribers to the facility, and comprise means 11 to facilitate a string of successive bidding occasions and ensure that on each of them only one successful bid is allowed; means 28, 30 to ensure that a subscription occasion precedes each bidding occasion; means 20 to specify a number characteristic for the set, to specify this via means 28, 30 as the number of successive bidding occasions constituting a chain of such occasions within said string, means 18, 17 to associate an identified subscriber with a said chain, means 16 to check that in respect of such subscriber guarantees have been made of subscribing for that chain, and means 17, 34 to ensure that the subscriber's subscription expires at the end of said chain; and means 36, 37 to limit the number of successful bids that can be made within that chain by that identified subscriber.

Means 11 run the bidding facility. The party organising the bidding facility uses means 18 for input of information defining the strings. New subscribers access the site interactively via means 12 or, if temporary (i.e. their subscription will depend upon their success on a first bid), via means 13. Existing subscribers access the site via means 32for bidding. A subscriber can view, and possibly change, his profile via means 17. Subscribers, or possibly any visitors, can view information relating to this and other strings via means 26. Subscribers can view information relating to this string alone via means 24, e.g. for deciding whether to make a bid and for how much. Means 40 notifies temporary subscribers that their status has changed, either to being made a full subscriber or to having their subscription cancelled.

In one embodiment, means 17 ensure that an identified subscriber can participate in the facility for only one said chain in a said string; this manner of conducting bidding has a feature of the Singapore arrangement, in that it allows only one chain of bidding per subscriber, though the chains for different subscribers may overlap in time only partially, i.e. one continuing after another has finished.

In another embodiment, means 17 ensure that an identified subscriber can participate in the facility for not more than two of said chains in a said string at a time. Alternatively, in yet another embodiment, means 17 ensure that an identified subscriber can participate in the facility for only one said chain at a time in a said string.

In a further embodiment, means 17 ensure that a said string has only the length of one said chain; this manner of conducting bidding has a feature of the Singapore arrangement, in that it allows only one chain of bidding, and this is simultaneous for all subscribers.

The alternative to the last-mentioned embodiment is for means 17 to allow a said string to be longer than one said chain, which feature may be applied to any of the other embodiments.

FIG. 7 shows various connections to terminal means 50. These may all be connectable via a single channel, e.g. to a single terminal 50 operated by a subscriber or a potential subscriber who will see these various connections as options available to him at a single virtual electronic site. Such terminals 50 may be, for example, PCs (person al computers) connected by a public telephone network 51 (see FIG. 8) to the site on the Internet, or hole-in-he-wall ATMs. The whole embodiment may be a facility run by a bank, in which case the bank has a data-handling system which comprises not only the bank's ATMs as the terminals 50 but also the account-holding means 52 as well as providing data-handling means 10.

In closed circle embodiments, of the kinds mentioned above, guarantee and authorisation functions, and means such as 16, 46, 48, may not be needed.

With reference to particular uses of the FIG. 7 arrangement, data-handling means 10 comprise means 16 to provide an electronic site with secure entry for subscribers to the site, means 11 to provide the site with a facility for bidding, and means 36 to provide the site with a facility to ensure that a subsequent successful bid for an identified fungible object is not allowed for an identified subscriber who has made a predetermined number of winning bids for that object. Means 36 provide for said predetermined number to be two, or one. The means 16 can provide the site with a facility to check that a subscriber to the site has provided guarantees of making subscriptions in respect of a predetermined number of subscription occasions, preferably before allowing the subscriber to bid.

Means 18 can provide said site with a plurality of subdivisions, each adapted to allow bidding for a separate identified fungible object. Means 18 will then ensure that each of items 17 and 20 to 46 shown in FIG. 7 operate in a plurality of to each subdivision, e.g. simultaneously with respective different parts of each item, or sequentially with all the items in one mode for one subdivision, and then in another mode for another subdivision, and so on. it is also possible to provide each mode with a serial number, and a form of multiplexing may then be used where the actions of respective items for one mode need not be simultaneous, being linked together only by the serial number, although the subscribers will not detect this. It is also possible for the actions of different items shown in FIG. 7 to be carried out by a single processing means suitably programmed, for example carrying out mode number 1, function 12, then mode number 1, function 14, then mode number 1, function 16, then mode number 1, function 17, and so on to mode number i, function 46, then mode number 2, function 12, then mode number 2, function 14, then mode number 2, function 16, and so on to mode number 2, function 46, and then mode number 3, and then mode number 4, and so on for all subdivisions, where the function numbers correspond to the actions of the like-numbered items in FIG. 7.

Means 18 may more particularly be adapted for a said fungible object to be a monetary fund, e.g. by ensuring that the display from means 17 is in monetary terms and is related to the subscriptions.

Means 18 and 20 can control means 17 and 22 to terminate a subdivision together with its fungible object.

Means 16, instead of providing general access to all subdivisions once a subscriber has been pre-authorised, may instead provide a said subdivision with secure entry, that is, to allow only those subscribers pre-authorised for that subdivision to access it.

Means 16 may, again, provide a facility to allow a subscriber access to only a predetermined limited number of subdivisions, e.g. related to the credit limit assigned to that subscriber.

Means 16 has been described as having a combined function of allowing a subscriber access and checking his creditworthiness. However, these functions may be separated: one function may be to check certain criteria and then allow generalised access; while another function may be to ensure adequate creditworthiness before allowing bidding. For example, a subscriber eager to participate in a particular chain may be willing to make subscription payments and not yet make bids, while his creditworthiness is being checked.

Means 16 may serve as guarantee-checking means 16 adapted to check, before a subscriber is allowed to bid, that he has creditworthiness or other guarantees for his continuing to subscribe on all subsequent bidding occasions of a predetermined number after he has won, and consequently give him pre-authorisation to bid. More particularly, means 16 may effect such a check (A) so as to issue the pre-authorisation before the subscriber is first allowed access to a subdivision, or (B) so as to issue the pre-authorisation before the subscriber is allowed access to the site for the purpose of bidding.

Means 42 may check that a winning subscriber is adequately guaranteed, and then calculate any tax or other pre-arranged deduction, his winnings to be paid out to him, and the part or parts of his winning bid to be paid out to each subscriber. Means 44 effect these payments, e.g. by reverse direct-debiting each subscriber.

In some embodiments of the FIG. 7 arrangement, means 18, 20, 22, e.g. in conjunction with means 17, ensure that a subdivision is not first opened for bidding until it has a specified number of subscribers, and it is then open for bidding only for those subscribers and only for the same specified number of bidding occasions.

Alternatively, though with similar effect, means 18, 20,22 are adapted to ensure that the subdivision is not opened for receiving subscriptions until it has the specified number of subscribers. Means 18 and 20 may then ensure that the subdivision terminates after a number of subscription and bidding occasions equal to the specified number of subscribers; this manner of conducting bidding has a feature of the Singapore arrangement, in that it allows only one chain of bidding, and this is simultaneous for all subscribers.

Again, means 18, 20, 22 may specify the maximum number of bidding occasions for each subscriber to the subdivision and ensure that the subdivision is allowed to continue for more than this number of bidding occasions. This is different from the Singapore arrangement.

Again, means 18, 20, 22 may ensure that a subdivision is not first opened for bidding until it has a predetermined minimum number of subscribers, and it is then open for bidding only for a specified maximum number of subscribers, and only for the same number of successive bidding occasions for each subscriber regardless of when he starts to subscribe to the subdivision.

In various forms of the FIG. 7 arrangement:
Means 17 and 34 may be arranged to ensure that once a subscriber has completed subscribing for the specified number of successive bidding occasions, his subscription expires.
Means 20 and 17 may be arranged to allow a subscriber, after his subscription expires, to open another subscription for the same fungible object.
Means 20 and 17 may be arranged to allow a subscriber to have a maximum of two subscriptions running at the same time for the same fungible object, not necessarily started at same time.
Means 13 are adapted to enable a subscriber upon starting a subscription to choose whether to bid on his first bidding occasion
Means 13 may alternatively be adapted to enable a subscriber upon starting a subscription to withdraw his subscription if he fails to win on his first bidding occasion.
Means 12, 13, 32, and possibly 44, 46, and display channels of means 17, 26, 24, 40 are connected or adapted to be connected to a funds transfer machine or other terminal 50, which term includes an automatic transfer machine (commonly known as ATM or a bank cash dispenser machine), for such machine to be used by a subscriber as a terminal for utilising the electronic site.
Means 46 comprise means 48 connected or adapted to be connected to, and/or adapted to interrogate, a financial account of a subscriber held on data-handling means 52, which may comprise a network of funds transfer machines 50, to obtain from the means 52 in relation to such account a guarantee of making subscriptions in respect of a predetermined number of subscription occasions.
Means 46 are adapted to render a direct debit to said financial account in respect of a subscription occasion for the electronic site.
Means 46 are adapted, in conjunction with the data-handling means of the financial account, to obtain a guaranteed payment in respect of a subscription occasion.
Means 12, 17, 26 comprise display means adapted to provide a display of those subdivisions for which a subscriber can be pre-authorised.
Means 17 comprise display means adapted to provide for an identified subscriber a display of those subdivisions for which he is pre-authorised.
Means 17 under the control of means 34 comprise display means adapted to provide for an identified subscriber pre-authorised for a subdivision a display of (details of) current bids (i.e. bids of the current bidding period) for that subdivision.
Means 17 under the control means 34 may, for some purposes, comprise display means adapted to provide for an identified subscriber pre-authorised for a subdivision a display of (details of) current and previous bids for that subdivision.
Means 18 and 20 serve to establish and/or register a credit limit for a said subdivision.
Means 16 serve to establish and/or register a credit limit for a subscriber.
Means 48, 16 and 17 serve to effect and/or control pre-authorisation for a subscriber for a said subdivision in dependence upon a credit limit for the subscriber and credit limits for that subdivision and for all other subdivisions for which the subscriber is pre-authorised.
More than one, or all, of the storage functions may be combined in a single register 17, e.g. register means 17 may comprise “current state” means 24.
Means 24 serve to store (details of) previous bids for a subdivision, e.g. obtained from means 34 and/or 38, and make these or some of them, or selected ones of them, or selected kinds of them, available for access by a subscriber.
Means 48, 16 and 17 serve to pre-authorise a subscriber for a subdivision.
Means 12,13 serve to offer a subscriber a choice whether to subscribe or not upon a particular access.
Monitor means 54 are adapted (e.g. by being connected to receive information from some or all of the other means 12 to 48) to gather information, and provide information by printing, displaying, storage or otherwise in a restricted access manner due to location, coded access or otherwise, e.g. at privately located means 56, so that suitable authorised higher level communicatees, e.g. organisers of the facility, can access the information but other communicatees, e.g. subscribers, unauthorised for this purpose can not.

Where there already exists an electronic site with sufficiently comprehensive data-handling means, suitable software can be formulated by one skilled in the art, by reference to the foregoing embodiments of the invention, to provide the data-handling means with the features of any of these embodiments.

Referring to FIG. 8, a network 51 embodying the invention comprises terminal means 50, operating means 53, and transmission means 58 which interconnect means 50 and 53, Terminal means 50 may comprise any of telephones (voice XML) 50/0, home/office computers 50/1, mobile phones 50/2, palm top communication devices 50/3, bank cash points 50/4, future communication devices which might include cookers 50/5, refrigerators 50/6, microwave ovens or other devices 50/7, clocks 50/8, watches 50/9. Transmission means 58 may comprise an Internet network 58 utilising the public telephone system 58, or a bank cash dispenser network 58. Operating means 53 may comprise a firewall 60, a network operating system 62 which sets up and/or maintains the operation of the network 50 in general terms, a web server 64 which may comprise a secure server 64, an online tracking and monitoring system 66 which comprises data-handling means 10 that provide a bidding facility embodying the invention, which means 10 may comprise, or be provided externally thereto within network 51 with, a back office financial and administrative system 68.

Since, clearly, some embodiments of the invention will be in the nature of a network, or otherwise distributed over a wide area, as exemplified in FIG. 8, it may be the case that only part of a working such embodiment is within the jurisdiction of the courts. For example, data-handling means 10 may be outside the jurisdiction, while working terminals 50 of the embodiment (or some of them) are within the jurisdiction, or vice versa.

Examples will now be given of possible operations of the FIG. 7 system.

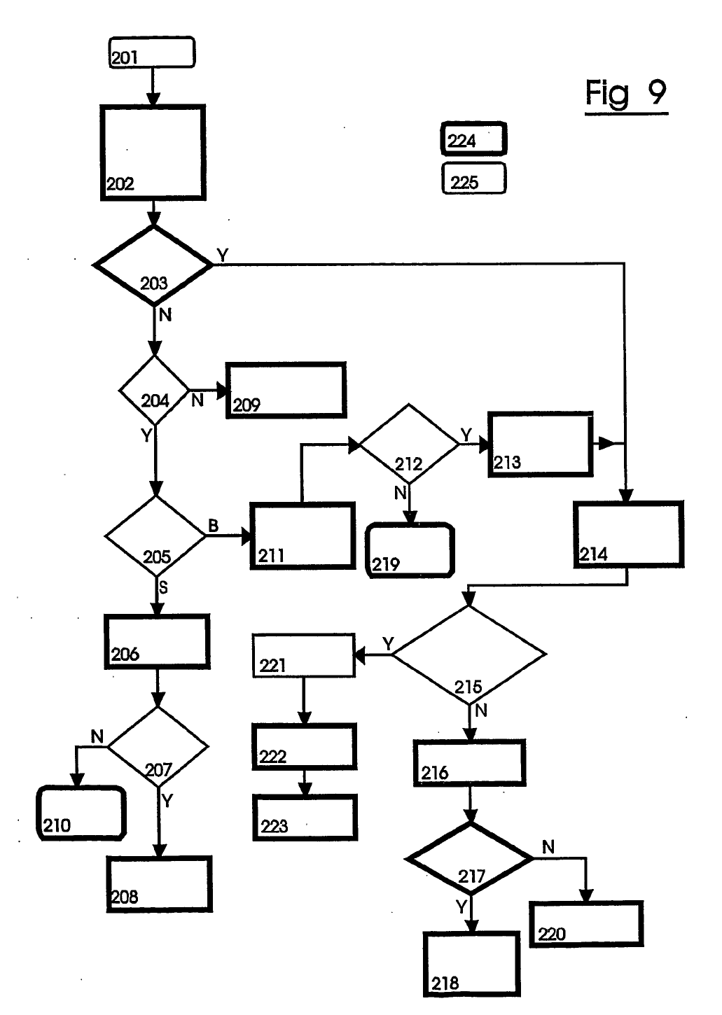

For example, FIG. 9 illustrates the steps of some possible procedures as viewed by the subscriber. Generally, steps generated by the system are indicated by a thick border as 224, while steps generated by the user are indicated by a thin border as 226. The subscriber makes a “login” step 201, the system responds with a “display user-related products” step 202. In step 203, the system invites the user to choose whether to “bid for products”. If the user's answer is “no” N, the user chooses in step 204 whether to “join new” string. If “yes” Y, the user can choose in step 205 whether to “borrow” B or “save” S. If to save, the system in step 206 offers the user a choice, “choose desired product”, and then in step 207 the user answers the question “agree to join?”. If “yes” Y, the system in step 208 tells the user “you are bound to the product”.

If at step 204 the user chose “no” N, the system at step 209 switches the user to “go to other services”. If at step 207 the user chose “no” N, the system at step 210 switches the user to “go to other services”.

If at step 205 the user chose to “borrow” B, the system in step 211 offers the user a choice, “choose desired product”, and then in step 212 the user answers the question “agree to join?”. If “yes” Y, the system in step 213 tells the user “you are bound to the product”, and at step 214 invites the user to “bid for the money”. In step 215, the user is asked “would you like to secure the bid?” (by bidding the maximum possible under the conditions set up for the string). If the user selects “no” N, the system allows the user to “join and set your bid” in step 216. In step 217 the system tells the user whether he is “successful”. If “yes” Y, the system notifies the user in step 218 “you will receive your money”. If “no” N, the system notifies the user in step 220 “you joined as an investor”, i.e. not as a borrower on this occasion.

If at step 212 the user chooses “no” N, the system at step 219 switches the user to “go to other services”.

If at step 215, the user chooses “yes” Y, the user at step 221 is invited to 'set your bid to maximum”, and the system responds at step 222 “your bid successful” and at step 223 “you will receive your money”.

If at step 203 the user chose “yes” Y, he is fast-tracked to step 214 to bid for the money.

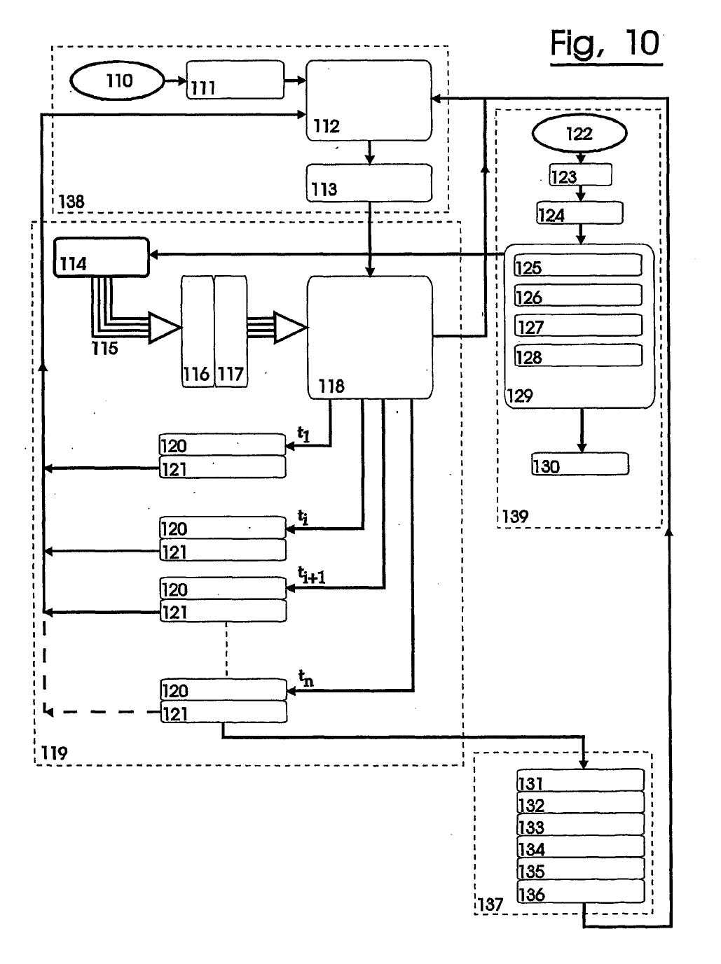

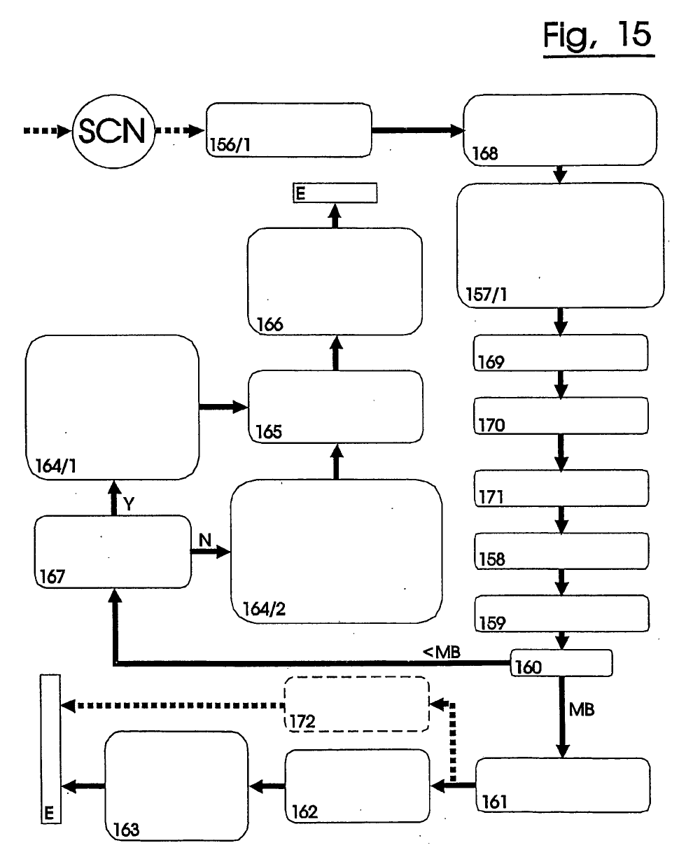

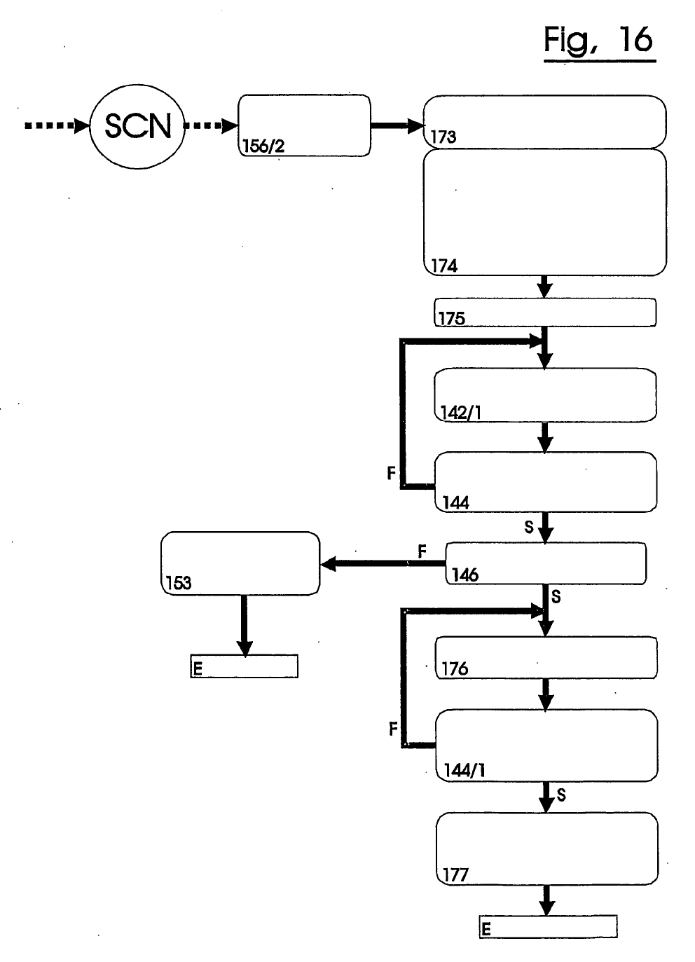

FIGS. 10 to 17

In the various FIGS. 10 to 17, the same reference is used for the same step, or a like or similar step, though it may be seen from slightly different aspects, as explained below in each case. Sometimes these aspects are differentiated by use of an oblique stroke and a suffix.

FIG. 10 is a flowchart showing examples of use of a system embodying the invention as illustrated in FIG. 7. In steps 138 the administrator of the embodiment sets up the embodiment; in steps 139 a user registers; in steps 119 users bid for the product; in steps 137 the embodiment carries out background functions after each bidding period has finished. The following references indicate the steps in more detail:

110=“administrator start”

111=“create new string”

112=“initialise the bidding facility”, assign initial bid per cent, number of vacancies available; “record current status of bidders” and their bids, e,g. number of bids left for each subscriber, and use this information to re-initialise the bidding facility

113=“open” the system for joining and bidding

114=subscribers' “input”

115=“bids”

116=“limit the number of bids” of a subscriber

117=“limit bidding” depending on the previous winnings

118=“control bidding”

119=“provide bidding facility”

120=“determine which bid is successful”

121=“remove previous winner if temporary” from list of subscribers

122=“user comes initially to the site and intends to buy new string”

123=“user accesses” the site (or attempts to access it)

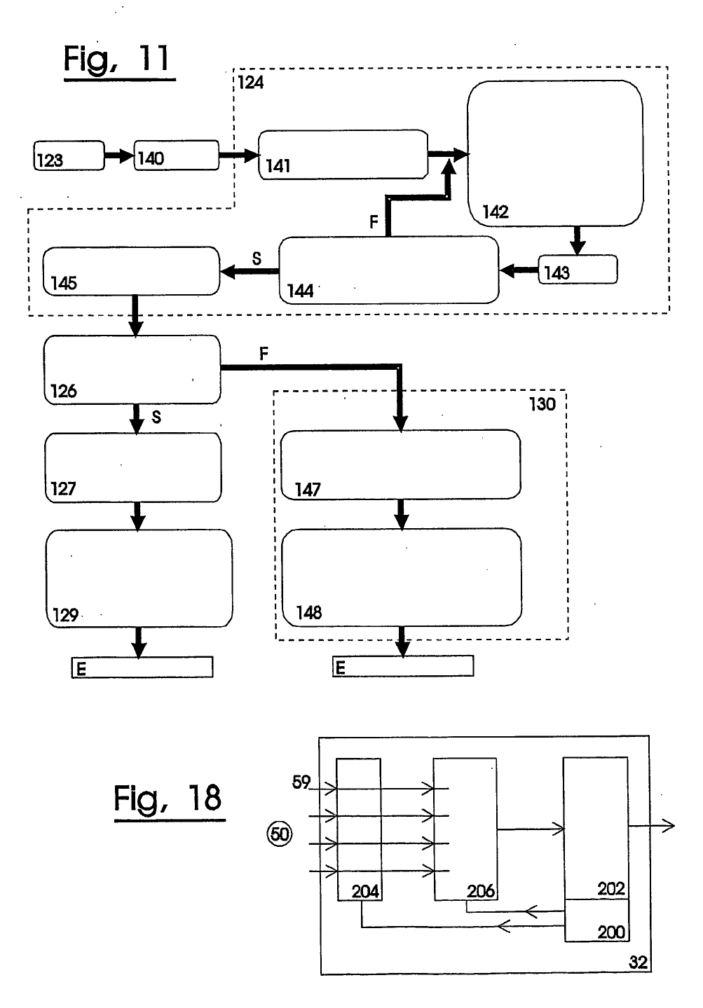

124=“verifying if user is registered” and, if not, passing him to a registration page (not shown in this Figure, but in FIG. 11)

125=“agree terms and conditions”

126=“verify guarantees”

127=“verify credit limit”

128=“check whether vacancy available”

129=“accept subscription for a chosen product”

130=“reject subscription”

131=“schedule share payments” to all subscribers

132=“schedule winning payment”

133=“amend subscriber's properties”

134=“find completing subscribers” (i.e. those who have completed their chain)

135=“Schedule paying out face value” for those who have not won the prize

136=“desubscribe completed subscribers”

137=“background actions” after bidding period finished

138=“initialising the system”

139=“joining subscribers to a string”

FIGS. 11 to 17 are flowcharts showing further details of uses of the FIG. 7 embodiment, and have reference to the FIG. 10 embodiment, The word “company” here refers to the body administering the system.

Use Cases

This section describes a use-case-driven approach (i.e. cases of procedures as seen by the user) for specifying software requirements for company customers. Each sub-section describes a use-case and its workflow, specifying corresponding company function and its customer requirement, starting with a summary of these and then continuing with a detailed “Procedure”. Each wording in quotes in the “Procedure” can be regarded as an abbreviated legend for the relevant box shown in the Figure.

| | |
|---|---|
| Title | New Registration |
| Workflow | |
| Description | The process for a potential user to register as a |
| | customer In order to have access to the customer |
| | area of the company website. |
| Business Requirements | Every customer needs to register before being |
| | able to access the customer area of the company |
| | website. |
| Issues | None |
| Assumption | Only one customer registration per user. |
| Actors | All Users |
| Related Use Cases | None |
| Precondition | Actor not registered |
| Post Condition | Actor will be able to login and access the |
| | customer secure area, if the company has verified |
| | and accepted the application. |

Note on “Assumption”:
There may be reasons, e.g. psychological, to want more than one user per registration, e.g. a husband and wife, e.g. so that both can play or use the facility but there is only the one registration shared between them, and therefore only the one credit limit for both of them and the same limited number of wins for both of them together, unless some other rules are offered.

Procedure. The “user accesses” the Internet, 123, then the “company website”, 140, then by clicking on the appropriate button “triggers access to the new customer registration area”, 141, and completes a “registration questionnaire page”, 142. Step 142 may require entry of the user's details, e.g. email identity, password, mother's maiden name, name, address, date of birth, employment details, residential details, and credit information. The credit information is information offered to the system so that it can make a simple credit check or maybe a more sophisticated guarantee check. There may be a step 143 involving “postal transmission” of information either way between the company and the user. The system then “checks the registration data”, 144; for example, K may validate the user information, i.e. check that it is all been entered correctly and in the right format. If at this point in the process there is failure F the process loops back to step 142. If there is success S the system “displays a thank you message”, 145, “We have received your application”. Steps 141 to 145 constitute registration of user step 124. They may include between steps 141 and 142 a step 125 for the user to “agree terms and conditions”.

The system then “verifies the application”, 126, e.g. verifies information with the employer and/or carries out a credit check and/or carries out a check against the electoral register. If step 126 fails, F, dt is followed by step 130 comprising: step 14 in which the system will “reject the user as a customer” and assign the reason for rejection, then step 148 in which the system will send out an “email rejection notification”, “We are sorry to inform you that your application was rejected for the following reason . . . Apply again after six months.”; this then is the “end” E of the New Registration procedure. If on the other hand step 146 succeeds, S, the user is “accepted as the company's customer” and the system will assign a credit limit and a monthly spending limit to the customer, 127, and will send out an “email acceptance notification”, 129, “We are pleased to inform you that your application has been accepted and credit limit is £n000 and your monthly spending limit is a £n00”, which is the “end” E of the New Registration procedure. In the FIG. 10 embodiment the user, between steps 127 and 128, selects a string (if this has not already been done) and the system in step 128 checks whether a vacancy is available. If so, the user registered in steps 129 is able to take action 114 as a subscriber for a selected string.

| | |
|---|---|
| Title | Customer Login |
| Workflow | |
| Description | The process for registered customers to gain |
| | access into the customer area of the |
| | company service portal. |
| Business Requirements | To enable registered users to login to customer |
| | area of the company web service portal to gain |
| | access subject to their customer credit limit and |
| | monthly spending limit. |
| Issues | Need to know about session expiry time due |
| | inactivity |
| Assumption | 1. The session will expire due to inactivity if the |
| | actor does not perform any action for n minutes |
| | (e.g. 5 min). |
| | 2. The actor can choose to logout of the site |
| | at any time. |
| Actors | Company registered users |
| Related Use Cases | Recover Password |
| Precondition | Actor has to be registered |
| Post Condition | Actor is recognised as a company customer |
| | and can access his/her account information |
| | (e.g. for all products currently subscribed to) and |
| | establish subscription rights to new products. |

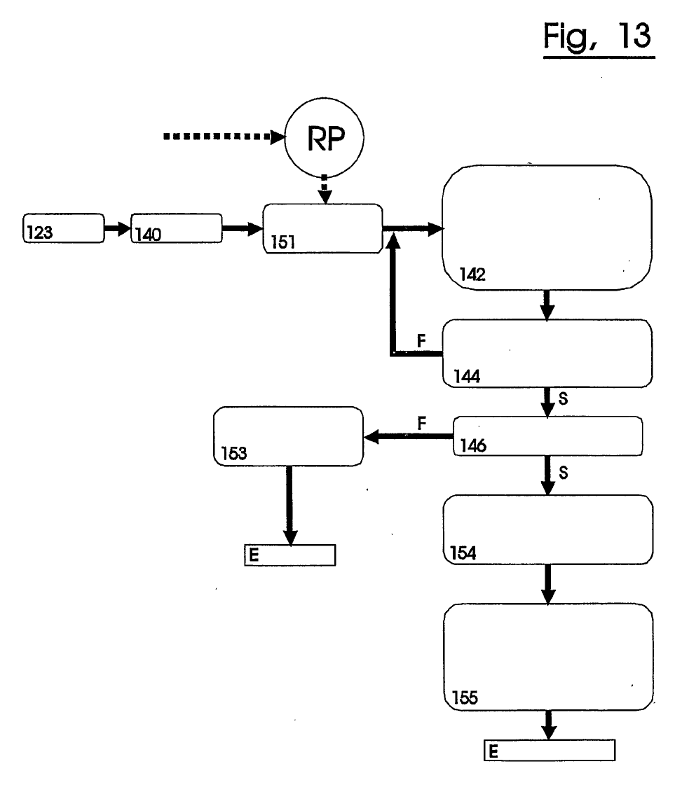

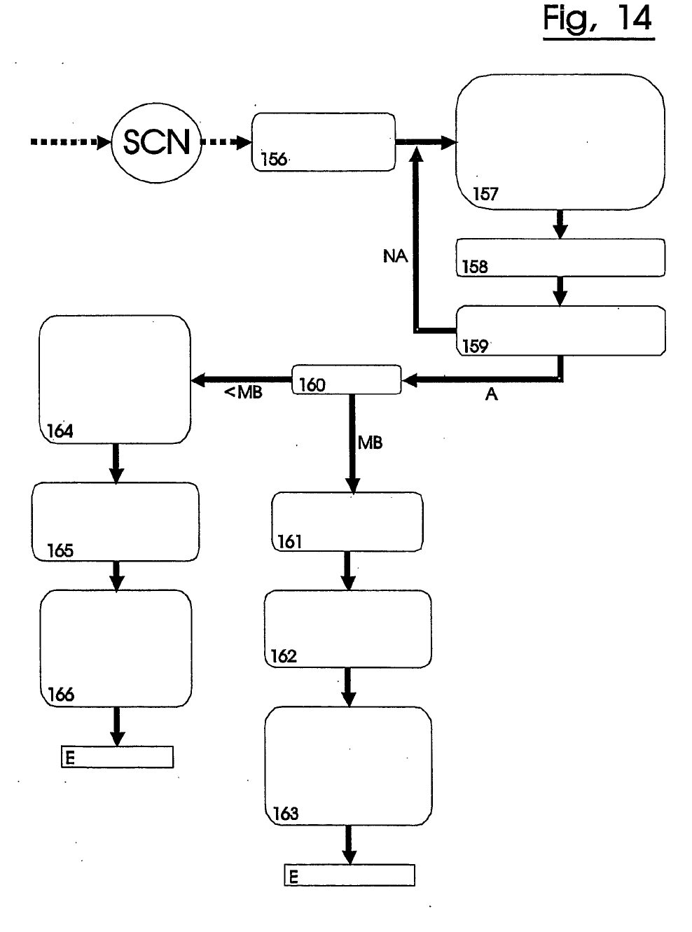

Procedure. Steps 123, 140, 141 are as for FIG. 11. Step 142 is, for this procedure, a requirement simply to input the password (and/or data field/s required by the system, e.g. login or customer iD). Step 146 is the validation of the customer by this password (or these other data). If there is failure F the customer is looped back to step 142 to try to input the password (or other data) again. This is tried three times. If there are more than three failures, the customer is switched to a Recover Password (RP) procedure described below in connection with FIG. 13. If the validation 146 succeeds, S, the “customer's person alised page” appears, 150, and the now secure customer is allowed Secure-Customer Navigation (SCN) around the site, respective examples of further actions being described below in connection with FIGS. 14, 15, 16, 17.

| | |
|---|---|
| Title | Recover Password |
| Workflow | |
| Description | Users have already registered with the company, |
| | but forgotten their password. They now have |
| | simple and easy way to request a new password. |
| Business Requirements | Customer should be allowed easily to request |
| | a new password. |
| Issues | This new password will have an expiry period. |
| | The user should change this password to his own |
| | within that period (e.g. 1 week) |
| Assumption | The customer's mother's maiden name |
| | and Email ID are unique identifiers, sufficient to |
| | identify the customer for this procedure. |
| Actors | Company registered users |
| Related Use Cases | Customer Login |
| Precondition | Actor has to be registered and active |
| Post Condition | 1. Actor has to login with the new password |
| | provided and change to his own within a |
| | notified expiry period. |
| | 2. Actor will be able to login to customer area. |

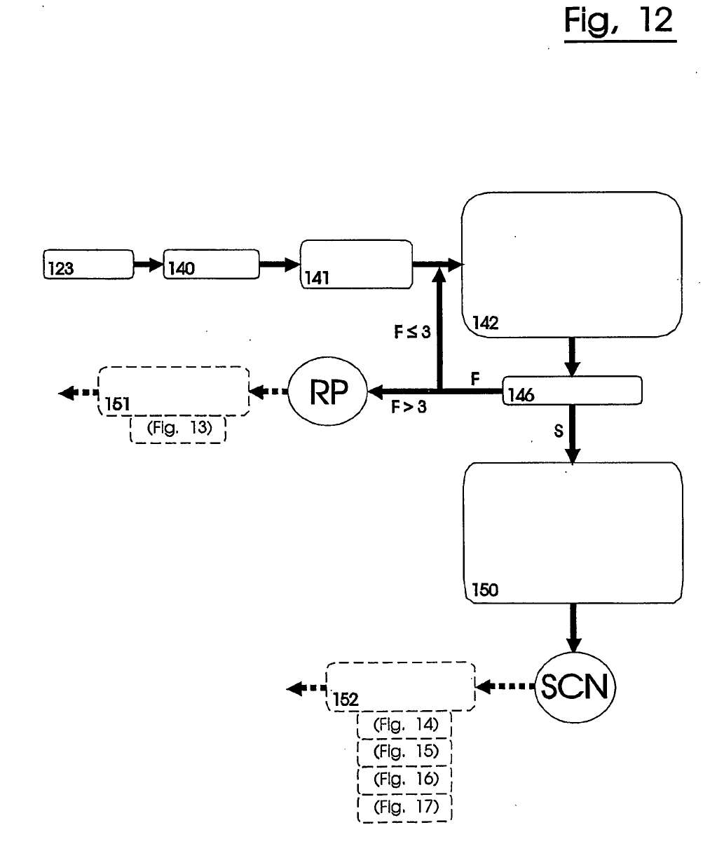

Procedure. The customer has tried in steps 123, 140, 141 and 142 of the FIG. 12 procedure to login, and failed more than three times to input the correct password. He/she is invited in step 151 to click on a button to “trigger to customer Recover Password page”. Or, the customer may come in fresh through steps 123, 140 to step 151. The customer is then passed to step 142 which, for this procedure, asks security questions but excluding the password. The information is validated as to format and completeness in step 144. If there is failure F customer is looped back to step 142. If there is success S the system passes to step 154 to “display message”: “Your new password will be sent to you by e-mail”, and to step 155 to provide an “email notification”: “Your new password is . . . You have to login with this password and change to your preferred one immediately/within . . . days”, if there is failure F at step 146, the system displays 153 an Error Page and the message “Your information is not valid”. In either case, this procedure comes to an end E.

| | |
|---|---|
| Title | Bidding on existing product |
| Workflow | |
| Description | The process for allowing the customer to |
| | bid on an existing product. |
| Business Requirements | To enable the customer to access the |
| | products for which he/she is currently |
| | subscribed and to bid subject to status. |
| Issues | Only bid on products which the customer has |
| | not won so far |
| Assumption | The customer is already logged into the |
| | customer area |
| Actors | Company-registered users who have bought one |
| | or more products. |
| Related Use Cases | Customer Login |
| Precondition | Actor has to be registered, and currently a |
| | subscriber to the product. |
| Post Condition | Actor may be asked to agree/confirm further |
| | terms and conditions to succeed in the bidding, |
| | e.g. to re-confirm or change the guarantee, |
| | bank details or payee details |

Procedure. The customer has proceeded in accordance with FIG. 2 to the SCN point and in step 156 can, subject to his/her status, “choose the product” for which to bid, and click on a button to trigger to the Bidding Page. This page is shown in step 157 to “display the latest bid stage” on the relevant product (the fund amount in the relevant string). The data may include for example: current bid %, current number of members, current share amount total share amount so far for this bidder, months left to completion of the bidder's chain within the string. The bidder may increase 158 his/her bid. The system will then require the bidder to “agree the terms” 159 applicable to this particular bid. If not agreed NA, the bidder is returned to step 157 to reconsider whether to make a bid 158. If agreed A, the system will verify 160 whether the bid % is the maximum. If the bid is the maximum possible bid, MB, for this string (on this occasion), e.g. 20%, the system will “display the message” 161: “You are the winner this month”. The system will then “remove the previously winning customer” (i.e. who made the previously highest bid during this bidding occasion) 162 from bidding for the current product if that customer had joined only conditionally (that he/she should win) and will “e-mail that customer” 163, “Your bid of x% has been beaten by a new bid for the maximum of y%. You cannot bid again for this product this month.” If at the verification step 160 the bid is less than the maximum possible bid, <MB, the system will “display the message” 164, “Your bid accepted and winner so far, but you have to wait until the end of the current bidding period to see whether yours is the winning bid or not.” As in steps 162, 163, the system will then “remove the previously winning customer” (i.e. who made the previously highest bid during this bidding occasion) 165 from bidding for the current product if that customer had joined only conditionally (that he/she should win) and will “e-mail that customer” 166, “Your bid of x% has been beaten by a new bid of y%. You can bid again before the end of the current bidding period.” In either case, after step 163 or 166, this procedure will end, E.

| | |
|---|---|
| Title | Buying a new product |
| Workflow | |
| Description | The process for allowing the customer to |
| | join new product. |
| Business Requirements | To enable the customer the ability to join |
| | in new products subject to credit limit and |
| | monthly spending limit. |
| Issues | None |
| Assumption | The customers already logged into the customer |
| | area |
| Actors | Company registered user who has enough |
| | credit limit and monthly spending limit to join |
| | new product. |
| Related Use Cases | Customer Login |
| Precondition | Actor has to be registered |
| Post Condition | Actor has to agree the terms and condition |
| | to join the new product. |

Procedure. The customer has proceeded in accordance with FIG. 2 to the SCN point and in step 156/1 can, subject to his/her status, “choose the product” for which to bid, and click on a button to trigger to the Joining Page 157/1. Before the customer reaches page 157/1, there may be interposed a step 168 in which the customer can “request the product type” and at what face value he wants to join. The page shown in step 157/1 will “display products” with the chosen face value, which the customer can then buy, i.e. In this step the system will find (and display) the products which are within his credit limit and monthly limit, and may also display a list of current members of the string, the maximum and minimum bid %, the current share amount, and so on, to enable the customer to find the right product. This is followed by steps 169 to “choose the product”, 170 to “display the detailed product information”, 171 to “ask, Would you like to bid?”, and then as with the FIG. 14 procedure continue with steps 158 to allow the customer to “request to increase the bid”, 159 to require the customer to “agree the terms” applicable to this particular bid, 160 for the system to verify whether the bid % is the maximum possible, upon a maximum possible bid (MB) 161 to “display the message”, “You are the winner this month”, 162 to remove the previously winning customer from the product if joined temporarily conditionally as for FIG. 14, and 163 to e-mail the previously winning customer, “Your bid of x% has been beaten by a new bid for the maximum of y%. You cannot bid again for this product this month.” There may be inserted after step 161 a step 172 to “create the payment schedule” for the customer declared winner in step 161. If at step 160 the bid is less than the maximum (<MB) the procedure moves to step 167 to ask, “Would you like to join if your bid falls?” if yes, Y, the system will “display the message” 164/1, “Your bid accepted and winning now, but you have to wait until the end of the current bidding period to see whether yours is the winning bid or not. Thank you for buying into the product.” If no, N, the system will “display the message”164/2, “Your bid accepted and winning now, but you have to wait until the end of the current bidding period to see whether yours is the winning bid or not. If your bid fails you will not be linked in to the product.” From either step 164/1 or step 164/2 the procedure passes to step 165 to “remove the customer previously winning customer” from bidding for the current product if that customer had joined only condition ally (that he/she should win) and the system will then “e-mall that customer” 166, “Your bid of x% has been beaten by a new bid of y%/. You can bid again before the end of the current bidding period.” in any of these cases, after step 163, 172 or 166, this procedure will end, E.

| | |
|---|---|
| Title | Manage Customer Profile |
| Workflow | |
| Description | The process for allowing the customer |
| | to amend his/her profile. |
| Business Requirements | To enable the customer the ability to amend |
| | his/her profile such as Email ID, Password, |
| | Address Changes, Employment Changes etc. |
| Issues | Customer cannot change some information such |
| | as DOB (date of birth), Mother's Maiden |
| | Name etc. |
| Assumption | The customer is already logged into the customer |
| | area |
| Actors | Company-registered users. |
| Related Use Cases | Customer Login |
| Precondition | Actor has to be registered |
| Post Condition | Actor has to pass the security questions test in |
| | order to be allowed to amend the information. |

Procedure. The customer has proceeded in accordance with FIG. 2 to the SCN point and in step 156/2 can click on a button to trigger to the My Profile Page 174 where he requests 173 to be allowed to change his profile. Page 174 then displays his profile and the groups of data in which the user can make changes, e.g. change e-mail ID or password, change personal details, change employment details, and so on. The user is then invited 175 to “choose the appropriate group”. The system will then “request security identification” 142/1, e.g. current e-mail ID, current password, Mother's maiden name, and so on. The system will then “validate the information” 144, i.e. check that all information has been entered correctly and in the right format. If the validation fails, F, the user is looped back to step 142/1. If the validation is a success, S, the system will “verify customer security data” 146 to check that the information provided is valid. If this fails, F, the system will display an Error Page 153 with the message “Your data are not valid”and the procedure will end E. If the verification 146 is a success, S, the user is invited to “change the profile”176. The system will then “validate the information” 144/1, i.e. check that all information has been entered correctly and in the right format. If the validation fails, F, the user is looped back to step 176. If the validation is a success, S, the system will “display a message” 177, “Your profile amended with the new data”. This procedure then ends E. Depending upon whether the display 174 shows details of profile (instead of only names of groups), the security routine 142, 144, 146, 153 may be inserted addition ally or instead before display 174.

| | |
|---|---|
| Title | Manage Customer Accounts and payments |
| Workflow | |
| Description | The process for allowing the customer to |
| | amend his/her account profile. |
| Business Requirements | To allow the customer to create (e.g. add to), |
| | amend or delete his credit account/s or any of |
| | them |
| Issues | Customer can amend but cannot delete a |
| | credit account of his if it is linked to an ongoing |
| | subscription, except by creating another |
| | (acceptable) account first |
| Assumption | The customer is already logged into the customer |
| | area |
| Actors | Company-registered users. |
| Related Use Cases | Customer Login |
| Precondition | Actor has to be registered |
| Post Condition | Actor has to pass the security questions test |
| | in order to be allowed to amend the information. |

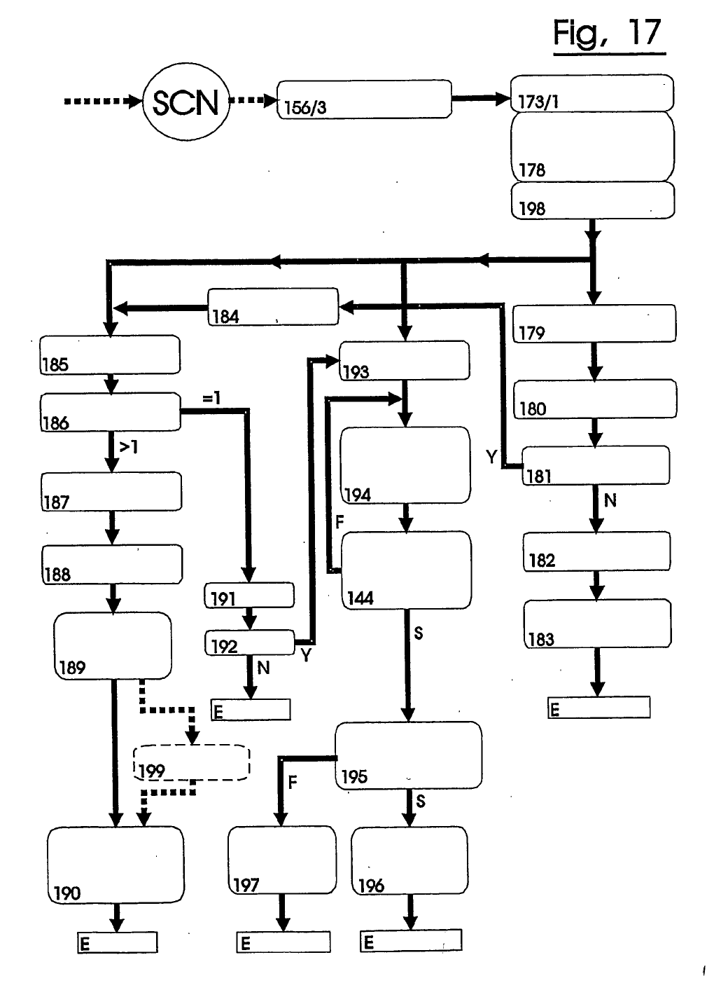

Procedure. The customer has proceeded in accordance with FIG. 2 to the SCN point and in step 156/3 can click on a button to trigger to the My Payments and Accounts Page 178. The security routine 142, 144, 146, 153 is inserted before display 178, though not shown in FIG. 17. Page 178 will then “display his existing account and payment details”, including details of payments to the system and from the system, and any products linked to the accounts. At page 178 he requests 173/1 to be allowed to change his payment and/or account details and is invited to choose 198 between deleting 179 an account, adding 193 a new account, or changing 185 payment details.

If the customer chooses to delete 179 an account he is invited to “choose the account to be deleted” 180. The system will then “verify if any payments are scheduled with this account” 181. If no, N, the system will “delete the account” 182 and “display the message” 183 “Your account number . . . deleted successfully”. The procedure then ends, E if the system at step 181 verifies yes, Y, there are payments scheduled with this account, the system invites the user to “re-assign the payment and then delete the account later” 184.

If the customer chooses to change 185 his payment details (or is required to do so, consequent upon step 184) (the only changes which he can make will involve the use of more than one account) the system will “verify the number of accounts” 186 that he has and, provided this is >1, he is invited to “select the account number” 187 and the system will then “display products linked to that account” 188. He is then invited to “change to existing different account” 189 as appropriate, e.g. changing some products over to another account. There may at this point be inserted a separate step 199 (shown in dashed lines) in which he or the system will “amend the payment schedule accordingly”. Finally, the system will “display the message” 190 appropriately, e.g. “Your direct debit successfully changed”. The procedure then ends, E. If at step 186 the system determines that he has only one account registered with the system the system will “display the message” 191, “You have to add another account to do this” and will then invite him 192 to “choose to add another account now”. If he chooses no, N, the procedure then ends, E if he chooses yes, Y, he is led to step 193.

If the customer chooses to add 193 a new account (whether at step 198 or at step 192) the system will “request account details” 194, e.g. account holder name, sort code, account number, bank address, and so on. The system will then “validate the information” 144, i.e. check that all information has been entered correctly and in the right form at. If this validation fails, F, the user is looped back to step 194. If the validation is a success, S, the system will “verify the account information” 195, asking the user to confirm that the details of this information are correct, and carrying out an external check, e.g. by actually accessing the account to see whether it is a valid and acceptable bank account for the purposes of the bidding. If the verification is a success, S the system will “display the message” 196, “Account successfully added”. If the verification is a failure, F, the system will “display the message” 197, “Error: it is not a valid account”. In either case, the procedure then ends, E.

In relation to the various flowcharts, it will be apparent to one skilled in the art that a system adapted to provide the various steps of any one of the flowchart embodiments may simply comprise means to carry out each of the steps illustrated for that embodiment, the various means being interconnected in the manner indicated in the flowcharts.

It will be readily apparent to one skilled in the art, in view of the above, how, in accordance with the invention, an existing website, e.g. an auction website, or data-handling means to provide the same, may be set up or operated to process information by a method which provides a facility for bidding and a limit condition concerning the number of bids that can be made by an identified subscriber, with or without a check of guarantees as to funds transfer from the subscriber before the subscriber is allowed to make a bid.

In these days of sophisticated development techniques, it is not necessary to specify the details of a broadly expressed feature, since the feature need simply be given to a development engineer to provide the details. Alternatively, the feature can simply be taken “off the shelf”. For example, to provide an electronic site on the Internet, this can betaken “off the shelf”. Providing a site with secure access is considered straightforward development. Providing an electronic site with an auction market facility, is now a well-known technique. To provide such a facility with the further said facility (c) in any of the forms mentioned above could now readily be done by a person skilled in the art, once apprised of the requirement.

The “guarantees” may, for example, be a line of creditworthiness or a second mortgage on property owned by the subscriber.

It will also be apparent to one skilled in the art, from the foregoing, how means can readily be provided for programming existing data-handling means, which programming means are adapted to programme the data-handling means so that when thus programmed they are, e.g. thereafter, in accordance with any of the embodiments described.

Likewise, it will be apparent how software can readily be produced which is adapted to provide data-handling means with any of the foregoing features. For example, only when the software is in place are the data-handling means so adapted.

Thus, it will be apparent how there can be provided a method of setting up or operating data-handling means to process information, or a method of processing information, in which method there is provided a facility for bidding and a limit condition concerning the number of bids that can be made by an identified subscriber.

More particularly, it will be apparent how to provide a method of setting up or operating data-handling means to process information, or a method of processing information, in which method there is provided a facility for bidding, a limit condition concerning the number of bids that can be made by an identified subscriber, and a check of guarantees as to funds transfer from the subscriber before the subscriber is allowed to make a bid.

It will be seen from the foregoing how there is provided a business system, which comprises data-handling means adapted to receive investment funds from a said subscriber and to pay out loan funds to a said subscriber.

It will also be apparent how the invention can be operated to provide a game, which comprises any such data-handling means and rules (which may be built into the data-handling means) for players to play the game as said subscribers.

It will also be apparent how the invention can be operated to provide a game which comprises use of any such data-handling means, according to rules (which may be built into the data-handling means) for players to play the game as said subscribers.

It will be seen from the above that there has been provided a method of conducting electronic commerce involving the exchange of investments and borrowings amongst a plurality of network registrants, the method comprising: accepting from a plurality of said network registrants offers of investment; auctioning groups of one or more of the investment offers among the network registrants; receiving from at least one of said network registrants a bid for a borrowing of a said group; ensuring that not more than a predetermined number of bids is successful from said one registrant.

It will be seen from the foregoing that there has been provided a machine-implementable method of auctioning in which bids are received but a bidder is not allowed to have more than a predetermined number of successful bids or during a predetermined interval. This may be used in a business method or in a game.

It will be seen that there has also been provided a method for digitally processing bids, which method ensures that a bidder does not have more than a predetermined number of successful bids.

It will be seen that there has also been provided a system for digitally processing bids, which system ensures that a bidder does not have more than a predetermined number of successful bids.

Theory of Operation

The following equations explain how the system operates for a string with a £1200 face value and £100 regular investment or repayment for a 12 months subscription period from January 2003 to December 2003.
Subscriber's profit=Total Share Profits−Total investment Payments+Single Money Borrowing−Total Administration Fees]

i.e.

$$Total Profit = [ {\sum }_{month k = Jan 2003}^{Dec 2003} Share {profit}_{k} - {\sum }_{month k = Jan 2003}^{Dec 2003} Regular {investment}_{k} ( e . g . £100 ) + Lump {Sum}_{k} - \frac{Lump {Sum}_{k} \times 5}{100} , where k is one of Jan 2003 … Dec 2003 ]$$

$$where , for a month k , \\ Share {profit}_{k} = Max \{ 5 , \frac{1200 \times {d}_{k}}{100 \times No of Current {Member}_{k}} \}$$

$$where 5 \leq {d}_{k} \leq 20 and 1 \leq No of Current {Member}_{k} \leq 20$$

$${LumpSum}_{k} = 1200 - \frac{1200 \times {d}_{k}}{100} where \{ \begin{matrix}{d}_{k} is the bidding \% \\ k ∈ Jan 2003 … Dec 2003\end{matrix}$$

From the above we can show the following:

dₖ≧5% guarantees that savers never lose any money and may gain a huge return;

loan borrowers earn money when Share Profit>Money Borrowing;

dₖ≦20% guarantees that the worst case scenario is better than credit card interest (>20%).

These features can be seen from the following illustration of Worst and Best cases for Saving and Borrowing.

Illustration

Assume that an investor joins a £200×12 thread, with face value £2400, and there is full membership on the thread throughout that investor's whole subscription period. (There can be better or worse cases if there is less than full membership.)

Saving—Worst Case

No bidding took place in the whole subscription period. The particular subscriber did not participate in any bidding and was just saving his money in the subscription period. (He received the regulatory minimum share amount.)

| | PAYMENT | RECEIPT |
|---|---|---|
| Amount paid by the subscriber (£200 * 12) | 2400.00 | |
| Share amount received by subscriber in total | | 120.00 |
| (£10 * 12) | | |
| Final payout amount from the company | | 2400.00 |
| Administration charge (5% of the payout) | 120.00 | |
| £2400 * 5% | | |
| Total | 2520.00 | 2520.00 |

| | |
|---|---|
| Difference between payment & receipt | NIL |
| Gain/(Loss) | |

At the end of his subscription period, the subscriber comes out as indifferent, he neither gained nor lost any money.

Saving—Best Case

The bidding took place at maximum level (i.e. 20%) throughout the subscription period and the particular subscriber did not bid or draw any money.

| | PAYMENT | RECEIPT |
|---|---|---|
| Amount paid by the subscriber (£200 * 12) | 2400.00 | |
| Share amount received by subscriber in total | | 480.00 |
| (£40 * 12) | | |
| Final payout amount from the company | | 2400.00 |
| Administration charge (5% of the payout) | 120.00 | |
| £2400 * 5% | | |
| Total | 2520.00 | 2880.00 |

| | |
|---|---|
| Difference between payment & receipt | 360.00 |
| Gain/(Loss) | |

At the end of his subscription period, the subscriber gained £360.00 on top of his savings.

Borrowing—Worst Case

The bidding to took place at the minimum (5%) throughout the subscription period (for other subscriptions) and the particular subscriber obtained his/her money at the maximum bidding amount (i.e. he bid and drew (borrowed) at 20%).

| | PAYMENT | RECEIPT |
|---|---|---|
| Amount paid by the subscriber (£200 * 12) | 2400.00 | |
| Share amount received by subscriber in total | | 150.00 |
| (£10 * 11 + £40 * 1) - 11 bids at minimum | | |
| and 1 at maximum | | |
| Payout amount from the company | | 1920.00 |
| Administration charge (5% of the payout) | 96.00 | |
| £1920 * 5% | | |
| Total | 2496.00 | 2070.00 |

| | |
|---|---|
| Difference between payment & receipt | (426.00) |
| Gain/(Loss) | |

At the end of his subscription period, the subscriber Lost £426.00 in total, by borrowing at worst discounting.

Borrowing—Best Case

The bidding took place. at the maximum throughout the subscription period and the particular subscriber obtained his/her money at the minimum bidding amount

| | PAYMENT | RECEIPT |
|---|---|---|
| Amount paid by the subscriber (£200 * 12) | 2400.00 | |
| Share amount received by subscriber in total | | 450.00 |
| (£40 * 11 + £10 * 1) - 11 bids | | |
| at maximum and 1 at minimum | | |
| Payout amount from the company | | 2280.00 |
| Administration charge (5% of the payout) | 114.00 | |
| £2280 * 5% | | |
| Total | 2514.00 | 2730.00 |

| | |
|---|---|
| Difference between payment & receipt | 216.00 |
| Gain/(Loss) | |

At the end of his subscription period, the subscriber gains £216.00 in total, even though he borrows money, e.g. early in the period.

Terminal Appearance

Table 1 below shows typically what might appear to the user on a screen of a PC terminal connected into the system, e.g. after he has selected a range of products or product types. The Table shows that the products available on the next 1st of the month are of types A, B, C, on the 10th A, D, and so on, and he has chosen to view products of type A.

The left-hand column and the first block (5 lines) of the right-hand column would appear initially. The next block down shows further data for that type, the next block the layout of data, the next blocks the data so laid out for Strings 12345, 12346 . . . 12360.

If the user then uses his mouse to make his cursor pointer hover over, for example, the data in the left-hand column for string 12345, the next block in the right hand column will appear, i.e. the Historical Data Picture for String 12345, which may be a histogram as shown though probably much more detailed or may be an actual graphic picture. If he then clicks his mouse pointer on the Buy Button for that String, the third block Buy String in the right-hand column will appear, for String 12345. The remainder of the right-hand column will then appear progressively as he clicks on his chosen answer to each successive question. “Selection Box” will give the possible answers among which he may make his selection, e.g. for “Account No” his accounts registered with the system, for “Bid %” the permitted bids, e.g. whole integer percents from 5% to 20%. Finally, he can click on “Submit” to submit his choice.

As seen from Table 1, another possible feature of the embodiments is to maintain or afford the maintenance of a complete running record of all bids so that a user can view in realtime and preferably simultaneously as much of the picture (e.g. some or all of the bids on as many strings) as he wishes before having to decide whether to join and/or join conditionally and/or submit a bid.

TABLE 1

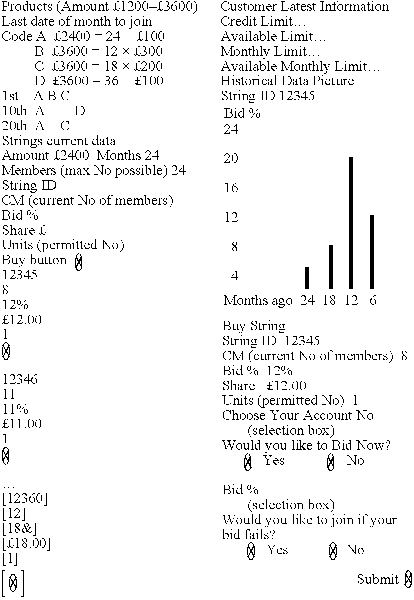

The system can avoid or reduce the need to use human judgment. For example, the bids can be limited to a range of e.g. 5-20% which will ensure comfortable/safer/easier working for all users as explained above, and to stepped e.g. Integral percentage values (or if preferred regular steps of 0.1, 0.2, 0.25, 0.5%, or even differing or irregular steps, e.g. steps closer together near the middle of the range, or near one or both ends of the range) which makes bidding easier and decision-making less onerous. For another example, the system takes over the determination of which is the highest bid and can infallibly and reliably avoid mistakes that would occur with a human operator, especially with large numbers of bids, e.g. since one scheme may have strings with a total of 50,000 bids in a single bidding period. For another example, the system can take over the function of credit checking and approval, and make this purely automatic, using machine-controlled determinations instead of human judgments. This can go even further, to extend credit checking to subsequently added products using data to hand without the need to obtain fresh data (unless the approval would be refused). For another example, the system can check automatically whether the rules are being obeyed, i.e. whether operation by users is in accordance with the rules of operation of the system, which otherwise would involve human judgment.

Further, visible reliability is an absolute requirement in order to obtain the confidence of users and potential users, in order to make operation of the system viable. The maintenance of a visibly fair and orderly operation would, with human operators, become increasingly difficult in direct relation to an increasing number of users and bids, with concomitant weakening and posssibly destruction of the system's reputation.

It will be apparent to one skilled in the art, that features of the different embodiments disclosed herein may be omitted, selected, combined or exchanged and the invention is considered to extend to any new and inventive combination thus formed. Where a preference or particularisation is stated, there is implied the possibility of its negative, i.e. a case in which that preference or particularisation is absent.

Additional to the aspects of the invention mentioned above, another aspect of the invention provides data-handling means, comprising:

means to note the identification of a subscriber inputting a value (which even includes simply selecting one of a set of values available in the data-handling means);

means to limit the number of such values input by such a subscriber;

and means to compare different such values (usually put in by different such subscribers) and choose one of them according to a rule, in the manner of an auction.

1-80. (canceled)

81. A computerized data handling system comprising:
a) a facility for bidding; and
b) a limit condition means for limiting the number of bids that can be made by an identified subscriber.

82. The system as in claim 81, comprising computerized data handling means for running a bidding facility comprising:
a) means for running a subscription and bidding facility for at least one set of subscribers to the facility; and
b) means to limit the number of successful bids that can be made by an identified subscriber in said at least one set of subscribers.

83. A computerized data handling system adapted to run a bidding facility having a data handling means that is adapted to run a subscription and bidding facility for at least one set of subscribers to the facility comprising:
a) means to facilitate a string of successive bidding occasions and to ensure that during each of said successive bidding occasions only one successful bid is allowed;
b) means to ensure that a subscription occasion precedes each bidding occasion; and
c) means to specify a number characteristic for a set, to specify this as a number of successive bidding occasions constituting a chain of such occasions within said string, to associate an identified subscriber with said chain, and to check that guarantees with respect to each subscriber have been made for subscribing for that chain, and to ensure that the subscriber's subscription expires at the end of said chain.

84. The system as in claim 82, further comprising a secure entry for said at least one set of subscribers to said site and wherein said means to limit the number of successful bids includes a facility to ensure that an identified subscriber who has made winning bids a predetermined number of times cannot subsequently make a successful bid.

85. The system as in claim 84, further comprising means to provide an electronic site with a facility to check that a subscriber to the site has provided a guarantee of making subscriptions with respect to a predetermined number of subscription occasions.

86. The system as in claim 83, further comprising a guarantee checking means adapted to check, before a subscriber is allowed to bid, that said subscriber is creditworthy, and can guarantee for continuing to subscribe on all subsequent bidding occasions of a predetermined number after the subscriber has won, and a means for giving the subscriber a pre-authorization to bid.

87. The system as in claim 86, further comprising a means to check that a winning subscriber is adequately guaranteed, means to calculate any tax or other pre-arranged deduction, and means to calculate any winnings to be paid out to him and any part or parts of said winning bid to be paid out to each subscriber.

88. The system as in claim 81, further comprising means to provide said site with a plurality of subdivisions each adapted to allow bidding for a separate identified fungible object.

89. The system as in claim 88, further comprising means to ensure that a subdivision is not first opened for bidding until it has a specified number of subscribers, and then opening said subdivision for only those subscribers and then only for a specified number of bidding occasions.

90. The system as in claim 89, further comprising means to ensure that a subscriber has completed subscribing for the specified number of successive bidding occasions regardless of when that subscriber subscribes to that subdivision.

91. The system as in claim 90, further comprising means to ensure that once a subscriber has completed subscribing for the specified number of bidding occasions, his subscription expires.

92. The system as in claim 91, further comprising means for allowing a subscriber to have a maximum of two subscriptions running at the same time for a same fungible object.

93. The system as in claim 92, further comprising means for holding a financial account to obtain a guaranteed payment from the financial account in respect to the subscription occasion.

94. The system as in claim 81, further comprising a means for establishing and registering a credit limit for a subscription.

95. The system as in claim 94, further comprising means for controlling a preauthorization for a subscriber for a subdivision in dependence upon a credit limit for the subscriber and credit limits for that subdivision and for all other subdivisions for which the subscriber is pre-authorized.

96. A method for conducting electronic commerce involving the exchange of investments and borrowing among a plurality of network registrants, the method comprising:
a) accepting from a plurality of network registrants different offers of investments;
b) auctioning groups of one or more investment offers among said network registrants;
c) receiving from at least one of said network registrants a bid for a borrowing of said group; and
d) ensuring that not more than a predetermined number of bids is successful from said at least one registrant taken from a plurality of network registrants.

97. The method as in claim 96, further comprising the step of ensuring that a bidder is not allowed to have more than a pretermined number of successful bids.

98. The method as in claim 96, further comprising the step of establishing and registering a credit limit for a subscription; and controlling a pre-authorization for a subscriber for a subdivision in dependence upon a credit limit for the subscriber and credit limits for that subdivision and for all other subdivisions for which the subscriber is pre-authorized.

99. The system as in claim 81, comprising a data handling means comprising:
a) means to note the identification of a subscriber inputting a value;
b) means to limit the number of such values input by said subscriber; and
c) means to compare different values and to choose one of these values according to a rule in the manner of an auction.
